(19) United States
(12) Patent Application Publication
(10) Pub. No.: US 2006/0024075 A1
(43) Pub. Date: Feb. 2, 2006

(54) Image forming system, image forming method, and program for implementing the method

(75) Inventor: Masao Watanabe, Toride-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/193,920

(22) Filed: Jul. 29, 2005

(30) Foreign Application Priority Data
Jul. 30, 2004 (JP) 2004-223359
Jul. 26, 2005 (JP) 2005-216061

(51) Int. Cl. G03G 15/00

(52) U.S. Cl. 399/45

(57) ABSTRACT

An image forming system which, when a sheet feeding cassette has been replaced with another sheet feeding cassette, can easily carry out image formation in accordance with a variety of information relating to the other sheet feeding cassette or the transfer sheets in the other sheet feeding cassette. Predetermined information related to respective transfer sheet storage units are stored in association with respective identification codes assigned to the transfer sheet storage units. When image formation is carried out on a transfer sheet, the identification code of the transfer sheet storage unit in which the transfer sheet is stored is acquired, and the predetermined information corresponding to the identification code is obtained. One or more image formation parameters are determined based on the obtained predetermined information, and image formation on the transfer sheet is carried out based on the determined one or more image formation parameters.

### BACKGROUND OF THE INVENTION

1. Field of the Invention

The present invention relates to an image forming system, an image forming method, and a program for implementing the method, and in particular to an image forming system comprised of an image forming apparatus, and an information storage apparatus, which are connected to each other via a network, an image forming method applied to the image forming system, and a program for causing a computer to execute the image forming method.

2. Description of the Related Art

Conventionally, in an IPv4 (Internet Protocol Version 4) network, there is a limit on the number of addresses that can be assigned to respective appliances connected to the network. This means that when an image forming apparatus is connected to the network and accessories, such as an automatic original feeding device (ADF) and a finisher, and sheet feeding cassettes are attached to the image forming apparatus, it is not possible to assign global addresses to the attached devices.

It is also common for an image forming apparatus to use a plurality of sheet feeding cassettes, with different types of sheets being placed in the respective sheet feeding cassettes. On the other hand, the image quality achieved when image formation is carried out by an image forming apparatus is greatly affected by the characteristics of the transfer sheet. For this reason, Japanese Laid-Open Patent Publication (Kokai) No. H08-305210 has proposed an image forming apparatus in which the type of transfer sheet in each sheet feeding cassette is registered in the image forming apparatus which carries out image formation based on such registered information.

However, with the above conventional image forming apparatus, when a sheet feeding cassette has been replaced with another sheet feeding cassette where the transfer sheet type is different, it has not been possible to carry out image formation based on the registered information unless the transfer sheet in the other sheet feeding cassette is newly registered.

The image quality achieved when image formation is carried out by the image forming apparatus is also affected by the state of the transfer sheets in the sheet feeding cassettes and the attachment positions of the sheet feeding cassettes on the image forming apparatus. However, it has not been possible to reflect such factors in the image forming parameters.

### SUMMARY OF THE INVENTION

It is an object of the present invention to provide an image forming system and an image forming method, which, when a sheet feeding cassette has been replaced with another sheet feeding cassette, can easily carry out image formation in accordance with a variety of information relating to the other sheet feeding cassette or the transfer sheets in the other sheet feeding cassette.

To attain the above object, in a first aspect of the present invention, there is provided an image forming system comprising an image forming apparatus, an information storage apparatus connected to the image forming apparatus via a network, a plurality of transfer sheet storage units that are detachably attached to the image forming apparatus, and feed transfer sheets to the image forming apparatus, the transfer sheet storage units being assigned respective identification codes, a predetermined information storage device that is provided in the information storage apparatus and stores predetermined information related to respective ones of the transfer sheet storage units, in association with the respective identification codes assigned to the plurality of transfer sheet storage units, a predetermined information obtaining device that is provided in the image forming apparatus and is operable when image formation is carried out on a transfer sheet, to acquire the identification code of the transfer sheet storage unit that stores the transfer sheet and obtain the predetermined information corresponding to the obtained identification code from the information storage apparatus, and an image forming device that is provided in the image forming apparatus, determines at least one image formation parameter based on the predetermined information obtained by the predetermined information obtaining device, and carries out image formation on the transfer sheet based on the determined image formation parameter.

Preferably, the predetermined information stored by the predetermined information storage device indicates characteristics of transfer sheets contained in the respective transfer sheet storage units.

Also preferably, the predetermined information stored by the predetermined information storage device indicates states of the transfer sheets contained in the respective transfer sheet storage units.

More preferably, the predetermined information indicative of the states of the transfer sheets indicates at least one of a standing time period and a peripheral temperature and humidity of transfer sheets contained in the respective transfer sheet storage units.

Preferably, the predetermined information stored by the predetermined information storage device comprises information related to attachment states of the respective transfer sheet storage units to the image forming apparatus.

Also preferably, the respective identification codes assigned to the plurality of transfer sheet storage units comprise addresses on the network.

Also preferably, the image forming apparatus is an electrophotographic image forming apparatus including a transfer device, and a photosensitive drum, and the image formation parameter determined by the image forming device includes at least one parameter selected from the group consisting of a voltage value of a high voltage supplied to the transfer device, a quantity of exposure light, an image formation position on the photosensitive drum, and a process speed of the image forming device.

To attain the above object, in a second aspect of the present invention, there is provided an image forming method applied to an image forming system including an image forming apparatus, a plurality of transfer sheet storage units that are detachably attached to the image forming apparatus, and feed transfer sheets to the image forming apparatus, and an information storage apparatus connected to the image forming apparatus via a network, the image forming method comprising a predetermined information storing step of storing predetermined information related to respective ones of the transfer sheet storage units in association with respective identification codes assigned to the plurality of transfer sheet storage units, in the information storage apparatus, a predetermined information obtaining step of acquiring an identification code of a transfer sheet storage unit that stores a transfer sheet on which image formation is carried out and obtaining the predetermined information corresponding to the obtained identification code from the information storage apparatus, when the image forming apparatus carries out image formation on the transfer sheet, and an image formation executing step of determining at least one image formation parameter based on the predetermined information obtained in the predetermined information obtaining step, and carrying out image formation on the transfer sheet based on the determined image formation parameter.

Preferably, the predetermined information stored in the predetermined information storage step indicates characteristics of transfer sheets contained in the respective transfer sheet storage units.

Also preferably, the predetermined information stored in the predetermined information storage step indicates states of the transfer sheets contained in the respective transfer sheet storage units.

Also preferably, the predetermined information stored in the predetermined information storage step comprises information related to attachment states of the respective transfer sheet storage units to the image forming apparatus.

Also preferably, the respective identification codes assigned to the plurality of transfer sheet storage units comprise addresses on the network.

Also preferably, the image forming apparatus is an electrophotographic image forming apparatus including a transfer device, and a photosensitive drum, and the image formation parameter determined in the image formation executing step includes at least one parameter selected from the group consisting of a voltage value of a high voltage supplied to the transfer device, a quantity of exposure light, an image formation position on the photosensitive drum, and a process speed of the image formation executing step.

There is also provided a program for causing a computer to execute the image forming method described above.

According to the present invention, predetermined information relating to a transfer sheet storage unit storing a transfer sheet is obtained and image formation is carried out on the transfer sheet based on image forming parameters determined based on the obtained predetermined information.

By doing so, in particular when a transfer sheet storage unit (a sheet feeding cassette or sheet feeding deck) has been replaced with another transfer sheet storage unit, favorable image formation can be easily carried out on transfer sheets fed from the other transfer sheet storage unit.

The above and other objects, features, and advantages of the invention will become more apparent from the following detailed description taken in conjunction with the accompanying drawings.

### BRIEF DESCRIPTION OF THE DRAWINGS

FIG. 1 is a diagram showing the construction of an image forming apparatus included in an image forming system according to an embodiment of the present invention;

FIGS. 2A and 2B are block diagrams showing the construction of a controller section in the image forming apparatus shown in FIG. 1;

FIG. 3 is a block diagram showing the internal construction of an image processing section inside the controller section shown in FIGS. 2A and 2B;

FIG. 4 is a diagram showing the construction of an image forming system including the image forming apparatus shown in FIG. 1;

FIG. 5 is a diagram showing the internal construction of a NIC section appearing in FIGS. 2A and 2B;

FIGS. 6A and 6B are diagrams showing the construction of an entire system that includes the image forming system shown in FIG. 4;

FIG. 7 is a diagram showing the basic structure or format of an IP address (i.e., an IPv6 address) in IPv6 protocol;

FIG. 8 is a diagram showing an example of notation of the IPv6 address;

FIG. 9 is a diagram showing the structure of a network address section of the IPv6 address;

FIG. 10 is a diagram showing the structure of an IPv6 link local address;

FIG. 11 is a diagram showing the structure of an IPv6 unicast address;

FIG. 12 is a diagram showing the structure of an IEEE/EUI-64 format MAC address assigned to an IPv6 compliant terminal apparatus;

FIG. 13 is a diagram showing the structure of an IEEE 802-format MAC address;

FIG. 14 is a flowchart showing the procedure of a generation process executed by an IPv6 compliant terminal apparatus to generate an IPv6 host address based on a MAC address;

FIG. 15 is a sequence diagram showing procedures for registering a host address section from a terminal manufacturing factory site in a terminal service provider site;

FIG. 16 is a diagram showing one example of a terminal apparatus attribute table stored by a terminal service administration server;

FIG. 17 is a flowchart showing the procedure of a process for generating a customer-based terminal service attribute table and registering the generated table in a customer-based terminal service database by a terminal service administration server of the terminal service provider site to which a customer-based terminal sale record table has been transmitted from a terminal sale administration server;

FIG. 18 is a diagram showing the structure of a customer-based terminal sale record table.

FIG. 19 is a flowchart showing the procedure of a network address search process executed by the terminal service administration server;

FIG. 20 shows the structure of the customer-based terminal service attribute table generated based on a terminal-based IPv6 host address list, a customer-based service list, and a customer network address list by a generating section at the terminal service provider site and registered in the customer-based terminal service database;

FIG. 21 is a sequence diagram showing the procedure of terminal registration and service provision carried out by a customer site and the terminal service provider site;

FIG. 22 is a diagram showing the structure of an IP packet transmitted from the customer site to the terminal service provider site;

FIG. 23 is a diagram showing the detailed structure of an IPv6 header of the IP packet;

FIG. 24 is a view showing a screen for having the user select a sheet feeding section whose sheet type is to be registered, out of sheet feeding sections of the IPv6 compliant terminal apparatus;

FIG. 25 is a view showing a screen for registering a sheet type for the sheet feeding section selected by the user;

FIG. 26 is a graph showing the relationship between a paper thickness X of standard transfer sheets and an optimal transfer current value Z;

FIG. 27 is a graph showing the relationship between the electrical resistance of a transfer sheet, and moreover a detected current indicative of a sheet thickness of the transfer sheet, and the optimal transfer current value;

FIG. 28 is a graph showing optimal transfer current values for respective detected current ranges produced by dividing a current range;

FIG. 29 is a diagram showing an example of settings of image formation parameters (fixing speed and fixing adjusted temperature) in accordance with an image quality mode and a sheet type for a transfer sheet whose basis weight is high;

FIG. 30 is a diagram showing an example of settings of the image formation parameters for a transfer sheet whose basis weight is medium; and

FIG. 31 is a diagram showing an example of settings of the image formation parameters for a transfer sheet whose basis weight is low.

### DETAILED DESCRIPTION OF THE PREFERRED EMBODIMENTS

The present invention will now be described in detail below with reference to the drawings showing a preferred embodiment thereof.

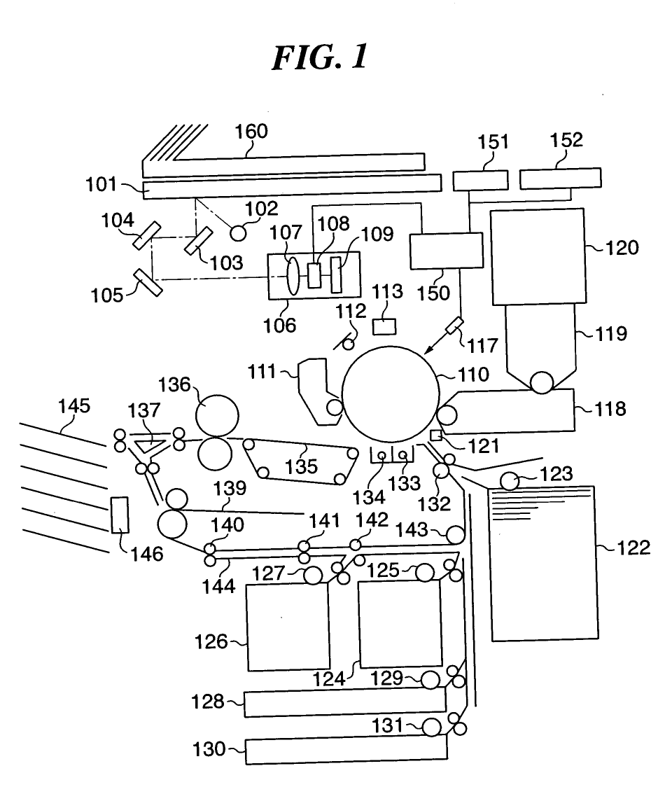

FIG. 1 is a diagram showing the construction of an image forming apparatus included in an image forming system according to an embodiment of the present invention.

In FIG. 1, reference numeral 101 designates an original platen glass. Originals fed from an automatic original feeding device 160 are successively placed at a predetermined position on the original platen glass 101. Reference numeral 102 designates an original irradiating lamp composed of a fluorescent lamp, for example, and exposes the original placed on the original platen glass 101. Reference numerals 103, 104, and 105 designate scanning mirrors that are housed within an optical scanning unit, not shown, and guide light reflected from the original to a CCD unit 106 while moving reciprocally across the surface of the original platen glass 101.

The CCD unit 106 is comprised of an image pickup device 108 composed of a CCD, for example, an image forming lens 107 that causes light reflected from the original to form an image on the image pickup device 108, a CCD driver 109 that drives the image pickup device 108, and others. An image signal outputted from the image pickup device 108 is converted into 8-bit digital data, for example, and inputted to a controller section 150.

Reference numeral 110 designates a photosensitive drum from which charge is removed by a pre-exposure lamp 112 before image formation. Reference numeral 113 designates a primary charger that uniformly charges the photosensitive drum 110. Reference numeral 117 designates a laser unit (exposing section) that is composed of a semiconductor laser, for example, and exposes the photosensitive drum 110 to form an electrostatic latent image based on image data processed by the controller section 150, which carries out image processing and controls the entire apparatus. Reference numeral 118 designates a developing device in which black developer (toner) is stored. Reference numeral 119 designates a buffer section that stores the toner and is replenished with the toner from a detachable toner container 120 set in the buffer section 119. The toner that is replenished to the buffer section 119 is supplied to the developing device 118 in accordance with the amount of toner inside the developing device 118. Reference numeral 121 designates a transfer precharger for applying a high voltage to the photosensitive drum 110 before a toner image that has been developed on the photosensitive drum 110 is transferred onto a sheet.

Reference numerals 122, 124, 126, 128, 130 respectively designate sheet feeding units, and as corresponding sheet feeding rollers 123, 125, 127, 129, and 131 are driven, transfer sheets are fed from the respective sheet feeding units into the apparatus. The fed transfer sheet is temporarily stopped at a position of a registration roller 132 and is then fed in synchronism with rotation of the photosensitive drum 110 on which the toner image has been formed. Reference numeral 133 designates a transfer charger that transfers the toner image developed on the photosensitive drum 110 onto the transfer sheet. Reference numeral 134 designates a separating charger that separates the transfer sheet from the photosensitive drum 110 after completion of a transfer operation. Toner that has not been transferred and remains on the photosensitive drum 110 is collected by a cleaner 111. Reference numeral 135 designates a conveying belt that conveys the transfer sheet for which the transfer operation has been completed to a fixing unit 136. The fixing unit 136 carries out a fixing process using heat, for example, on the transfer sheet.

Reference numeral 137 designates a flapper that sets a direction in which the transfer sheet for which the transfer operation has been completed is conveyed, and conveys the transfer sheet toward either a staple sorter 145 or an inverting path 139. Sheets discharged to the staple sorter 145 are sorted into bins, with a stapling section 146 stapling the sheets in accordance with instructions from the controller section 150. The inverting path 139 is used when sheets are discharged face-down and when two-sided copying is carried out. When face-down discharge is carried out, sheets are discharged after being inverted on the inverting path 139. When two-sided copying is carried out, sheets are conveyed from the inverting path 139 to a two-sided path 144. Reference numerals 140 to 142 designate sheet feeding rollers that convey a transfer sheet on the two-sided path 144 to a refeeding roller 143. The transfer sheet is conveyed by the sheet feeding rollers 140 to 142 and 143 in timing synchronized with sheets fed from the sheet feeding units 122, 124, 126, 128, and 130 and is conveyed to the position of the registration roller 132 once again.

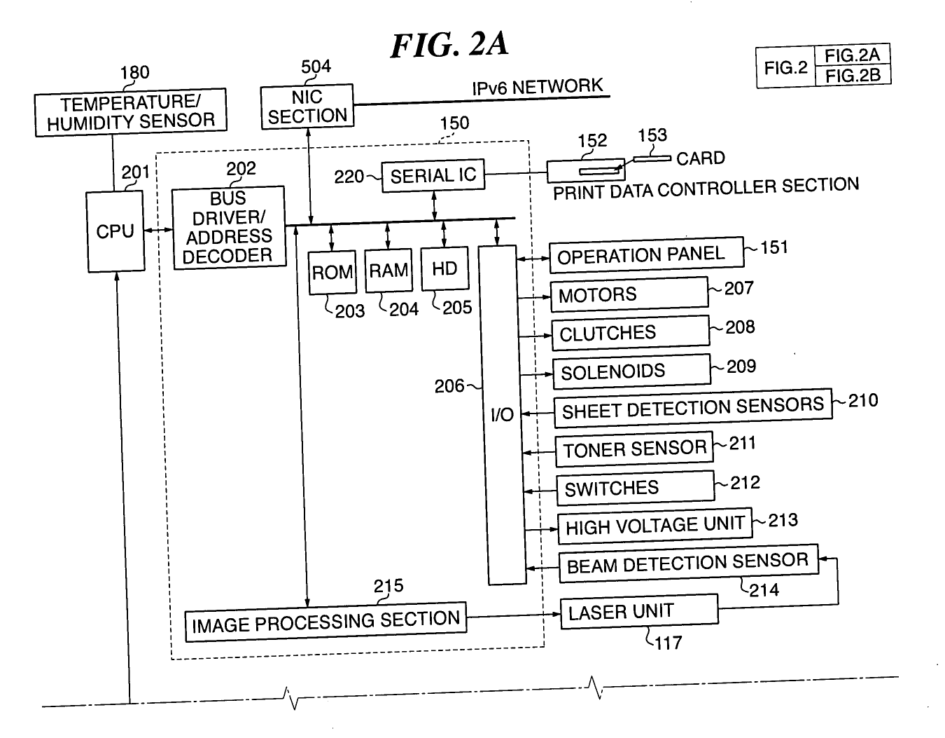

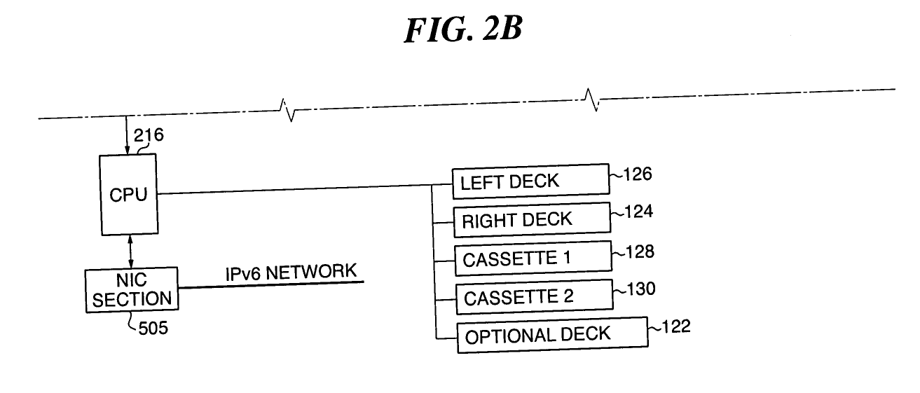

The controller section 150 is constructed as described later with reference to FIG. 2A, and carries out image formation operations in accordance with user instructions inputted via an operating panel 151. The operating panel 151 is comprised of an input section made up of input keys, and an output display section made up of a liquid crystal display and LEDs (Light Emitting Diodes). The user makes a key input via the input section and the output display section displays an operation state and the like of the image forming apparatus. Reference numeral 152 designates a print data controller section and is constructed so that a card called a control card can be attached. When the user inserts a control card into the image forming apparatus during a copying process carried out on the image forming apparatus, copying by the image forming apparatus is permitted and the number of copies produced is stored in the image forming apparatus main body separately for a user ID of the control card.

Although a method is used in which a control card on which a user ID is written is inserted into the image forming apparatus main body to enable the image forming apparatus to determine the user ID and manage the number of copies made, it is also possible to use a construction in which the number of copies is stored on the control card itself. For example, by incorporating a non-contact memory such as a ferroelectric memory in the control card, it is possible for the number of copies made to be written in the non-contact memory from the print data controller section 152.

FIGS. 2A and 2B are block diagrams showing the construction of the controller section 150 of the image forming apparatus shown in FIG. 1.

The controller section 150 is comprised of a CPU 201, a bus driver/address decoder 202, a read-only memory (ROM) 203, a random access memory (RAM) 204, an image data hard disk (HD) 205, an I/O interface 206, an image processing section 215, and a serial IC 220. An address bus and a data bus of the CPU 201 are connected to respective component elements of the controller section 150 via the bus driver/address decoder 202.

The ROM 203 stores control procedures (control programs) executed by the image forming apparatus main body. The CPU 201 successively reads and executes the control programs stored in the ROM 203 to control the entire image forming apparatus. The RAM 204 is used to store input data and provides a work storage area for the CPU 201.

The image data hard disk 205 stores data that has been inputted from the CCD unit 106 (see FIG. 1) and subjected to image processing. The image data hard disk 205 stores image data also in the case where the image forming apparatus is connected to a network or the like.

Connected to the I/O interface 206 are the operating panel 151 composed of an input/output section, motors 207 that drive a sheet feeding system, a conveying system, and an optical system, clutches 208, solenoids 209, and sheet detection sensors 210 for detecting conveyed sheets. A toner sensor 211 that detects a toner amount inside the developing device 118 is disposed inside the developing device 118, and an output signal from the toner sensor 211 is inputted to the I/O interface 206. Output signals from switches 212 for detecting home positions, door open/closed states, and the like of various devices are also inputted to the I/O interface 206. Reference numeral 213 designates a high voltage unit that outputs a high voltage to the primary charger 113, the developing device 118, the transfer precharger 121, the transfer charger 133, and the separating charger 134 in accordance with instructions from the CPU 201.

Reference numeral 180 designates a temperature/humidity sensor that detects temperature and humidity inside the image forming apparatus main body. A voltage value signal indicative of the temperature and a voltage value signal indicative of the humidity from the temperature/humidity sensor 180 are directly inputted to analog ports of the CPU 201, subjected to A/D conversion, and used in calculations as digital values.

An image signal is inputted to the image processing section 215 which carries out image processing, described later, and outputs a control signal to the laser unit 117 in accordance with the image data. The laser light outputted from the laser unit 117 is incident upon and exposes the photosensitive drum 110. A beam detection sensor 214 detects a light emitting state of the laser unit 117 in a non-image region on the photosensitive drum 110 and an output signal from the beam detection sensor 214 is inputted to the I/O interface 206.

The print data controller section 152 is connected to the serial IC 220. A card 153 can be attached to the print data controller section 152.

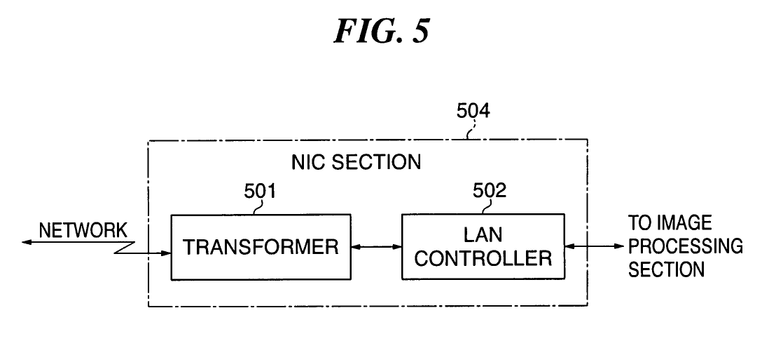

Reference numerals 504, 505 designate NIC (Network Interface Cards) sections that are connected to an IPv6 (Internet Protocol Version 6) network. The NIC sections 504, 505 will be described in detail later with reference to FIG. 5. A CPU 216 controls the sheet feeding units 122, 124, 126, 128, and 130 and communicates with the main CPU 201. The sheet feeding units 122, 124, 126, 128, and 130 are directly connected to the IPv6 network by the NIC section 505 and cassettes or decks attached to the respective sheet feeding units are assigned IPv6 addresses. The CPU 216 obtains an address assigned to cassettes or decks via the respective sheet feeding units and informs the CPU 201 of the address. The CPU 201 acquires information related to the corresponding cassette or deck and the transfer sheets stored in/on the cassette or deck, and carries out image formation based on such information. No detailed description will be given, but a contact or non-contact memory is attached to the cassette or deck attached to each sheet feeding unit, an address value is written in the contact or non-contact memory, and the address value is read out via the sheet feeding unit.

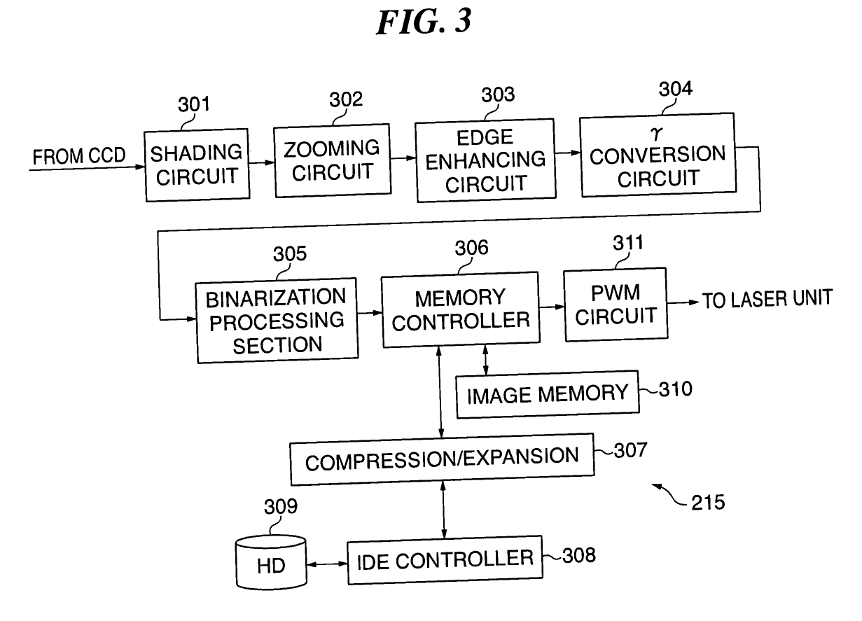

FIG. 3 is a block diagram showing the internal construction of the image processing section 215 inside the controller section 150 shown in FIG. 2A.

When the image signal produced by converting the electric signal from the image pickup device (CCD) 108 is sent to the image processing section 215, first, variations between pixels are corrected by a shading circuit 301. A zooming circuit 302 then carries out decimation processing on data when reduced image formation is carried out or interpolates data when enlarged image formation is carried out. Next, an edge enhancing circuit 303 enhances edges in the image by second order differentiation in a window of 5 by 5 pixels, for example. Since the image data obtained here is luminance data, to carry out conversion of the image data into density data suited to printer output, a y conversion circuit 304 carries out data conversion by referring to a table. The image data converted into density data is inputted to a binarization section 305 where the multivalue data is converted into binary data by Error Diffusion (ED), for example.

The image data converted into binary data is inputted to a memory controller 306. The memory controller 306 selectively outputs the inputted image data and image data in an image memory 310 implemented by a hard disk, for example, to a PWM circuit 311. Alternatively, the memory controller 306 may calculate a logical OR for such data and outputs the result to the PWM circuit 311. When read/write control over the image memory 310 is carried out by a memory control section (not shown) to rotate an image, control is carried out over read addresses for image data in the image memory 310. The PWM circuit 311 converts the inputted image data into a light intensity signal for the laser and outputs pulse signals with pulsewidths corresponding to the image density to the laser unit 117.

Reference numeral 309 designates a hard disk for storing image data. A large amount of image data picked up using the image pickup device 108 is sent by the memory controller 306 to a compression/expansion section 307 where the image data is subjected to image compression. The compressed image data is stored in the hard disk 309 using a transfer method determined by an IDE controller 308 that controls the hard disk 309. Conversely, image data read from the hard disk 309 is expanded by the compression/expansion section 307 and transferred to the memory controller 306. After being subjected to pulsewidth modulation by the PWM circuit 311, the image data is outputted to the laser unit 117.

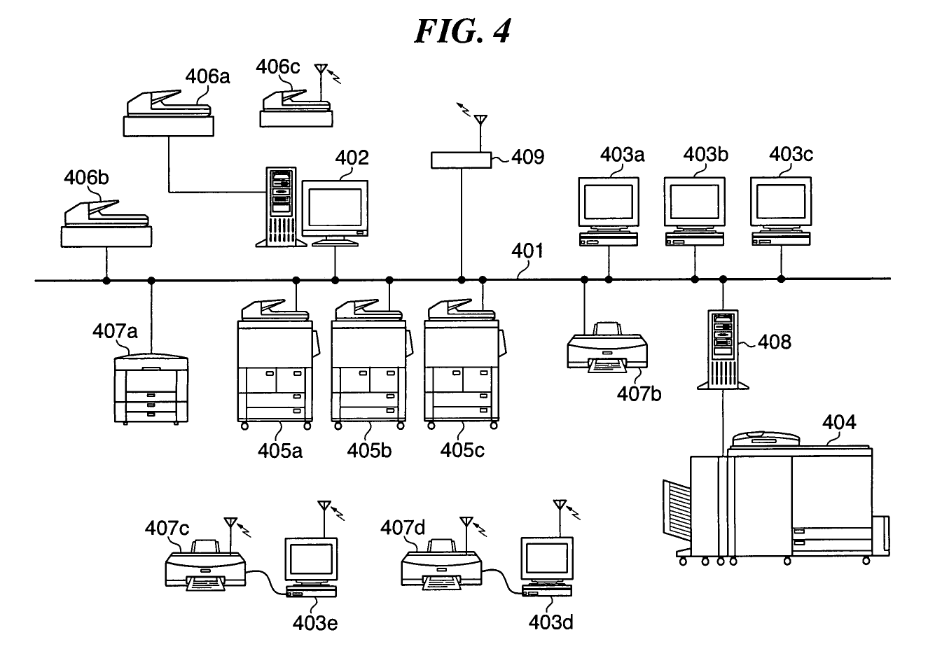

FIG. 4 is a diagram showing the construction of the image forming system including the image forming apparatus shown in FIG. 1.

The image forming system, as shown in FIG. 4, is comprised of a document server computer (hereinafter referred to as the “document server”) 402 as an information processing apparatus, client computers 403a to 403e as client terminal apparatuses, a color MFP (Multi-Function Peripheral) 404, black-and-white MFPs 405a to 405c as image forming apparatuses, printers 407a to 407d as image output apparatuses, and scanners 406a to 406c as image input apparatuses, these apparatuses being connected to a network 401.

The client computers 403a to 403e are client terminal apparatuses that send jobs to the document server 402, and although not shown, a plurality of other client terminal apparatuses may also be connected. Hereinafter, the client computers 403a to 403e will be collectively referred to as the “client computer 403”.

The document server 402 stores and manages job data sent from the client computer 403 on a job-by-job basis. Job data is required when image formation is carried out by the color MFP 404, the black-and-white MFPs 405a to 405c, and the printers 407a to 407d.

The black-and-white MFPs 405a to 405c carry out monochromatic scanning and printing and can also carry out simplified color scanning and color printing at low resolution or in binary.

The color MFP 404 carries out full-color scanning and printing at high resolution and with good gradation.

The scanners 406a to 406c read images of paper documents. The scanner 406a is connected to the document server 402, the scanner 406b is directly connected to the IPv6 network 401, and the scanner 406c is connected to the IPv6 network 401 via a wireless apparatus 409.

The hardware configuration of the document server 402 is such that a NIC (Network Interface Card) is connected by an interface called a PCI bus to a part called a “motherboard” on which a CPU, memory, and the like are mounted.

Application software for carrying out so-called “DTP” (Desk Top Publishing) is executed by the client computer 403 to generate and edit various kinds of documents and figures. The client computer 403 converts the generated documents and figures into Page Description Language data and sends the data via the network 401 to the color MFP 404 and the black-and-white MFPs 405a to 405c to have the documents and figures printed out.

The color MFP 404 and the black-and-white MFPs 405a to 405c respectively have communication means for exchanging information with the document server 402 via the network 401. Information about and the states of the color MFP 404 and the black-and-white MFPs 405a to 405c are sequentially provided to the document server 402 or to the client computer 403 via the document server 402. In addition, the document server 402 or the client computer 403 has utility software that receives and processes such information so that the color MFP 404 and the black-and-white MFPs 405a to 405c are managed by the document server 402 or the client computer 403.

FIG. 5 is a diagram showing the internal construction of the NIC section 504 appearing in FIG. 2A. Note that although the NIC section 504 will be described here as being included in the image forming apparatuses (the color MFP 404 and the black-and-white MFPs 405a to 405c), components corresponding to the NIC section 504 are respectively incorporated in the printers 407a to 407d and the scanners 406a to 406c appearing in FIG. 4.

The NIC section 504 functions as an interface for a network, and obtains information from external or peripheral apparatuses and supplies information to external or peripheral apparatuses using, for example, an Ethernet (registered trademark) cable, such as 10Base-T/100Base-TX. “Ethernet” refers to a LAN (Local Area Network) codeveloped by Xerox, Intel and DEC.

When information has been obtained from an external or peripheral apparatus, first, a signal representing the information is subjected to voltage conversion by a transformer 501, and the resulting signal is sent to a LAN controller 502. The LAN controller 502 internally includes first and second buffer memories (not shown), and after information sent from the transformer 501 has been stored in the first buffer memory, it is determined whether the information is required information before the information is stored in the second buffer memory. After this, information is read from the second buffer memory and sent to the image processing section 215 appearing in FIG. 2A.

When information is provided to an external or peripheral apparatus, data sent from the image processing section 215 is appended with necessary information by the LAN controller 502 and is sent to the network via the transformer 501.

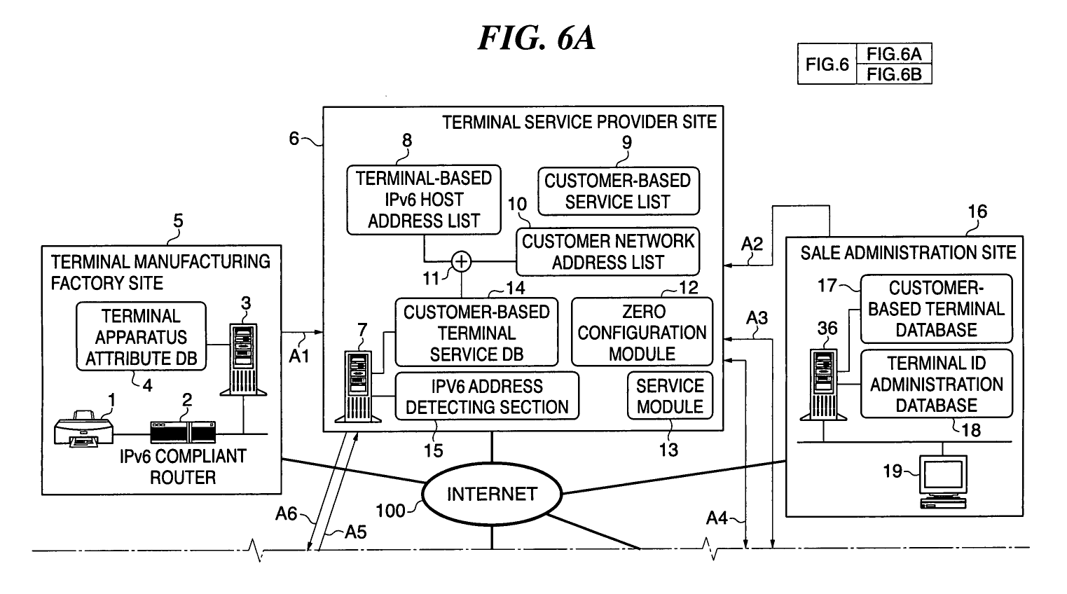

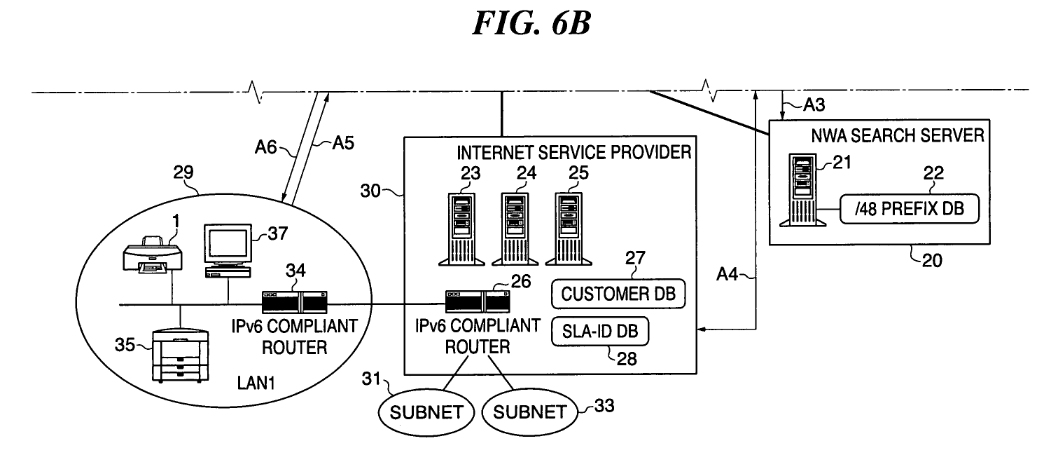

FIGS. 6A and 6B are diagrams showing the construction of an entire system that includes the image forming system shown in FIG. 4. The image forming system shown in FIG. 4 corresponds to a LAN 29 appearing in FIG. 6B.

In FIG. 6A, reference numeral 1 designates a terminal apparatus that corresponds to the image forming apparatus shown in FIG. 1 and is compliant with IPv6 protocol. By using a global IP address with an IPv6 address format as an ID on the network, the IPv6 compliant terminal apparatus 1 can connect to the Internet 100 and use various services on the Internet 100.

The IPv6 compliant terminal apparatus 1 is manufactured at a factory by a terminal apparatus manufacturer. Reference numeral 5 designates a terminal manufacturing factory site where the factory is located. The terminal manufacturing factory site 5 has a function for transmitting various information on the IPv6 compliant terminal apparatus 1 at a manufacturing stage to the Internet 100.

After an assembly process on a production line and a function inspection process, the IPv6 compliant terminal apparatus 1 is connected to an IPv6 compliant router 2 in an IPv6 host address registration process. The IPv6 compliant terminal apparatus 1 connected to the IPv6 compliant router 2 automatically generates an IPv6 host address based on a MAC address of a network interface processing device in the IPv6 compliant terminal apparatus 1, and notifies the IPv6 compliant router 2 of the generated host address.

Reference numeral 3 designates a terminal manufacturing administration server that associates the IPv6 host address of the IPv6 compliant terminal apparatus 1 notified to the IPv6 compliant router 2 with a terminal apparatus ID and terminal apparatus attribute information and stores the associated information in a terminal apparatus attribute database 4 as a terminal apparatus attribute table. After this, the terminal manufacturing administration server 3 reads the terminal apparatus ID and terminal apparatus attribute information of the IPv6 compliant terminal apparatus 1 from the terminal apparatus attribute table, sets the read information in a payload section of an IPv6 packet, reads the IPv6 host address of the IPv6 compliant terminal apparatus 1 from the terminal apparatus attribute table, sets the host address as a transmitter address in a header section of the IPv6 packet, and transmits the IPv6 packet as a terminal registration IPv6 packet to a terminal service provider site 6 (arrow A1 in FIG. 6A).

The terminal service provider site 6 receives the terminal registration IPv6 packet and extracts the IPv6 host address from the transmitter address in the header section of the received terminal registration IPv6 packet. The terminal service provider site 6 also extracts the terminal apparatus ID and the terminal apparatus attribute information from the payload section and stores the ID and attribute information in a terminal-based IPv6 host address list 8.

In this way, before the IPv6 compliant terminal apparatus 1 is shipped, the IPv6 host address, terminal apparatus ID, and terminal apparatus attribute information of the IPv6 compliant terminal apparatus 1 are notified to the terminal service provider site 6. When registration of the IPv6 host address at the terminal service provider site 6 is complete, the IPv6 compliant terminal apparatus 1 is shipped.

By doing so, the states of sheet feeding units (sheet feeding decks, sheet feeding cassettes, etc.) when the IPv6 compliant terminal apparatus 1 (the image forming apparatus) is shipped from the factory are managed by the terminal manufacturing administration server 3 as terminal information attribute information. When the IPv6 compliant terminal apparatus 1 is shipped from the factory, there are individual differences between sheet feeding units. That is, actual attachment positions and actual sheet conveying positions when sheet feeding decks and sheet feeding cassettes are attached to an image forming apparatus somewhat differ between individual sheet feeding units. Accordingly, the attachment positions and actual sheet conveying positions of the sheet feeding decks and sheet feeding cassettes when the image forming apparatus is shipped from the factory are managed as individual sheet feeding deck/sheet feeding cassette information for the shipped image forming apparatus. Such information is used to adjust an image position during image formation operations.

The shipped IPv6 compliant terminal apparatus 1 is stocked and sold by a dealer of the terminal apparatus manufacturer or related terminal apparatus retailer. The dealer or retailer is provided with a sale administration site 16. A sale record, customer information, and the like for the IPv6 compliant terminal apparatus 1 are notified to the terminal service provider site 6 from the sale administration site 16 via the Internet 100.

Reference numeral 19 at the sale administration site 16 designates a client terminal, and when a customer purchases an IPv6 compliant terminal apparatus 1, information such as terminal information, customer information, and a service contract content is inputted to the client terminal 19. The terminal information, customer information, and service contract content inputted to the client terminal 19 are sent to a terminal sale administration server 36. The terminal sale administration server 36 extracts the terminal apparatus ID of the sold IPv6 compliant terminal apparatus 1 from a terminal ID administration database 18, associates the terminal information, customer information, and service contract content sent from the client terminal 19 with the terminal apparatus ID, and stores the associated information in a customer-based terminal database 17 as table information. The terminal sale administration server 36 reads the table information from the customer-based terminal database 17 and notifies the terminal service provider site 6 via the Internet 100 (arrow A2 in FIG. 6A).

The terminal service provider site 6 extracts the terminal apparatus ID from the notified table information, associates permitted services and permitted applications, which can be used by the customer according to the content of a sale contract, with the terminal apparatus ID, and registers the associated information in a customer-based service list 9. In the case where the IPv6 compliant terminal apparatus 1 is connected to the Internet 100, the terminal service provider site 6 obtains information such as the name of an Internet service provider (hereinafter “ISP”) that provides an Internet connection service, a domain name, and an organization/enterprise name. Based on any of the obtained ISP name, domain name, and organization/enterprise name, the terminal service provider site 6 enquires to a network address search site 20 to acquire a network address of the network to which the IPv6 compliant terminal apparatus 1 is connected (arrow A3 in FIGS. 6A and 6B).

At the network address search site 20, a NWA (Network Address) search server 21 refers to a /48 prefix database 22 based on any of the ISP name, domain name, and organization/enterprise name sent from the terminal service provider site 6 to specify the network address of the network to which the IPv6 compliant terminal apparatus 1 is connected, and sends the network address in response to the terminal service provider site 6 (arrow A3 in FIGS. 6A and 6B).

The terminal service provider site 6 that has received the network address enquires to the ISP 30, which provides the Internet connection service to a LAN (Local Area Network) to which the IPv6 compliant terminal apparatus 1 is connected, about the network address of the LAN connected to the IPv6 compliant terminal apparatus 1 (arrow A4 in FIGS. 6A and 6B).

The ISP 30 is a site that provides the IPv6 compliant terminal apparatus 1 with a service for connecting to the Internet 100. Reference numeral 23 in the ISP 30 designates a mail server that manages transmission and reception of electronic mail by users of the ISP 30 on the Internet 100. Reference numeral 24 designates a DNS server that provides a service for searching for an IP address from a domain name in response to an Internet connection request from a customer that has designated the domain name. Reference numeral 25 designates a gateway server with a function that manages and monitors a connection between the ISP 30 and the Internet 100. Reference numeral 26 designates an IPv6 compliant router with a routing function that transfers IP packets to a receiver in accordance with a transfer request for the IP packets sent from a customer terminal connected to the network.

Customer networks (subnets) are connected to the IPv6 compliant router 26. That is, as shown by the LAN 29 and LANs 31 and 33, small-scale subnets are constructed for the respective customers and the IP packets respectively transmitted from the IPv6 compliant terminal apparatuses included in such subnets are transferred to the IPv6 compliant router 26 and sent from the gateway server 25 to the Internet 100.

Reference numeral 27 in the ISP 30 designates a customer database in which customer information on customers who use an Internet connection service of the ISP 30 is stored. Reference numeral 28 designates a SLA (Site-Level Aggregation)-ID database in which an ID of a network is stored for each customer. By using such IDs, it is possible to specify a network for each customer.

The ISP 30 that has received, from the terminal service provider site 6, the enquiry about the LAN network address of the LAN to which the IPv6 compliant terminal apparatus 1 is connected refers to the customer database 27 and the SLA-ID database 28 to specify the network address of the LAN to which the IPv6 compliant terminal apparatus 1 is connected, and sends the LAN network address in reply to the terminal service provider site 6 (arrow A4 in FIGS. 6A and 6B). The terminal service provider site 6 that has received the network address stores the network address in a customer network address list 10.

At the terminal service provider site 6, a generating section 11 refers to the terminal-based IPv6 host address list 8 in which the terminal IDs, the terminal apparatus attribute information, and the IPv6 host addresses are stored in association, the customer-based service list 9 in which the terminal IDs are stored in association with the permitted services and permitted applications, and the customer network address list 10 in which the network addresses of the LANs to which the IPv6 compliant terminal apparatuses are connected are stored, generates a customer-based terminal service attribute table in which the terminal apparatus ID, IPv6 host address, network address, permitted services and permitted applications are all associated and stores the customer-based terminal service attribute table in a customer-based terminal service database 14. An IPv6 address detecting section 15 in a terminal service administration server 7 has a function for extracting an IPv6 global IP address of a transmitter from a header section of an IPv6 packet transmitted from the IPv6 compliant terminal apparatus.

When the IPv6 compliant terminal apparatus 1 sold by the retailer to the customer is connected to the LAN 29 used by the customer, first, the IPv6 compliant terminal apparatus 1 generates an IPv6 host address based on a MAC address assigned to the network interface processing device of the IPv6 compliant terminal apparatus 1.

An IPv6 compliant router 34 is provided on the LAN 29. The IPv6 compliant router 34 receives the IPv6 host address from the IPv6 compliant terminal apparatus 1 and confirms that the IPv6 host address is not identical to IPv6 host addresses of other IPv6 compliant terminal apparatuses 35, 37 on the LAN 29. The IPv6 compliant router 34 then notifies the IPv6 compliant terminal apparatus 1 of the network address of the LAN 29. The IPv6 compliant terminal apparatus 1 that has received the notification of the network address determines the global IP address based on the network address. When the global IP address has been determined, the IPv6 compliant terminal apparatus 1 switches to initial setting mode and transfers a use registration IP packet to the terminal service administration server 7 of the terminal service provider site 6 (arrow A5 in FIGS. 6A and 6B).

In the terminal service administration server 7 that has received the use registration IP packet, the IPv6 address detecting section 15 extracts the global IP address of the IPv6 compliant terminal apparatus 1 that is the transmitter from the received use registration IP packet. The terminal service administration server 7 then searches the customer-based terminal service attribute table stored in the customer-based terminal service database 14 based on the extracted global IP address, extracts initial setting information, sheet type registration information, permitted applications and permitted services, and provides such information via the Internet 100 and the ISP 30 to the IPv6 compliant terminal apparatus 1 on the LAN 29 (arrow A6 in FIGS. 6A and 6B).

Next, the structure of an IP address in IPv6 protocol will be described.

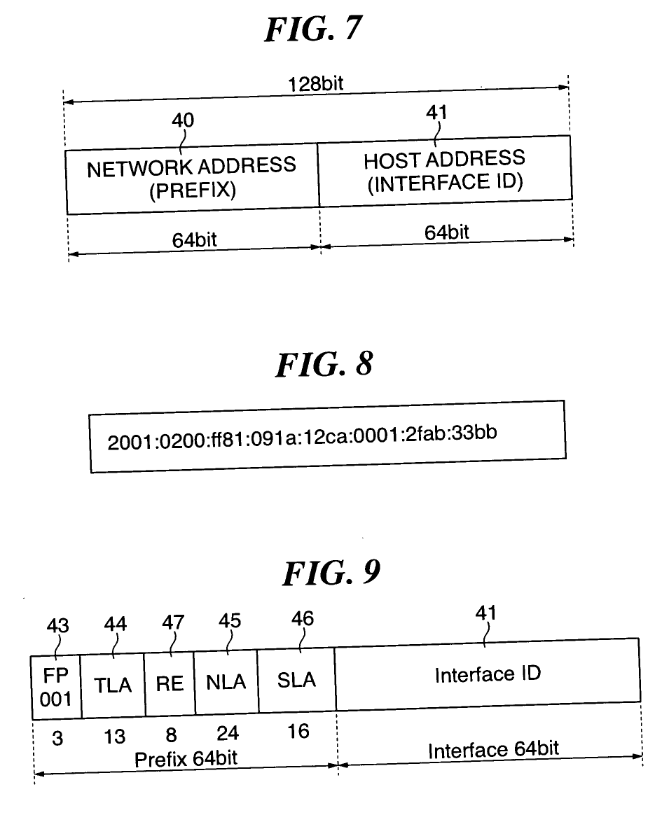

FIG. 7 is a diagram showing the basic structure or format of an IP address (i.e., an IPv6 address) in IPv6 protocol.

An IP address (IPv6 address) is composed of 128 binary digits. In FIG. 7, reference numeral 40 designates a network address section which occupies the first 64 bits in the 128 bits and is called a “prefix”. A network address for identifying the network to which an IPv6 compliant terminal apparatus is connected is contained in the network address section 40. The network address is notified from an IPv6-compliant router positioned inside a link on the network (a link being a range where communication on a data link layer is possible). Reference numeral 41 designates a host address section that occupies the latter 64 bits in the 128 bits and is called an “interface ID”. A host address that has been automatically generated by the IPv6 compliant terminal apparatus itself based on the MAC address assigned to the network interface processing device provided in the IPv6 compliant terminal apparatus is contained in the host address section 41. The MAC address is a globally unique ID that a vendor who provides a network interface processing device assigns to an individual network interface processing device and is used for communication on the data link layer. The host address generated from the MAC address is also globally unique.

Note that the host address only needs to be unique within the link to which the corresponding terminal apparatus is connected and is not limited to being generated based on a MAC address. That is, so long as there is no identical host address inside the same link, i.e., so long as the host address is unique within the link, the host address will be unique on the Internet, which is composed of a plurality of interconnected links, due to the network address being different to the network addresses of all other links. This ensures that the IPv6 global IP address is unique.

FIG. 8 is a diagram showing an example of notation of the IPv6 address.

The 128 bits of the IPv6 address are divided into 16-bit sections by colons, with each 16-bit section being expressed in hexadecimal, i.e., “0 to ffff”.

FIG. 9 is a diagram showing the structure of the network address section 40 of the IPv6 address.

According to notation rules for the IPv6 address, when there are consecutive zeros, such parts can be abbreviated. That is, when all of the 16 bits partitioned by colons are zeros, the notation “0” can be used instead of “0000”. In addition, a string of contiguous zeroes can be replaced by a double colon. For example, “fe80:0:0:0:0:0:0:1” can be expressed as “fe80::1”. However, the “::” notation can only be used at one position.

In IPv6 protocol, an address architecture where addresses are assigned hierarchically in accordance with network topology is used. Network addresses are assigned hierarchically from major ISPs to end user networks, and a number of paths are expressed after being aggregated to a single path. More specifically, addresses are assigned after aggregating a plurality of pieces of route (path) information where the number of next hops in a router are the same to a single piece of route information.

In FIG. 9, reference numeral 43 designates an address-type identifier FP (Format Prefix). When the address-type identifier FP 43 is “001”, this shows that the IP address is aggregatable. An identifier (ID) of a wide-area backbone ISP is set in a TLA (Top-Level Aggregation Identifier) 44. An identifier (ID) of an ISP that has been assigned an address block from the ISP with the ID set in the TLA 44 is set in a NLA (Next-Level Aggregation Identifier) 45. Using this kind of address assigning policy, network addresses that are hierarchically aggregated from higher level ISPs can be assigned. This facilitates the management of route control that was hitherto complex, and is one of the characteristics of IPv6 protocol.

RE (Reserved) 47 is a reserved bit.

Reference numeral 46 designates a SLA (Site-Level Aggregation Identifier). SLA 46 is a region in which is written a subnet address which can be freely set by sites of respective organizations assigned an address block from a provider with an address expressed by the upper 48 bits, i.e., FP 43 to NLA 45. As the subnet address, 65, 535 subnets can be defined using the 16 bits of SLA 46. In IPv6 protocol, by incorporating the subnet address setting region at the base protocol level in the 64-bit network address section 40, a network address system that can suppress disorder in the address system caused by the generation of subnets according to user policies that differ between users, i.e., a network address system that can be aggregated, is realized.

In IPv6 protocol, various IP addresses are defined according to the ranges in which such addresses are valid. For example, valid addresses in the data link layer (hereinafter, this range will be called the “link”) managed by an IPv6 router provided on the network are defined according to IPv6 protocol as “link local addresses”.

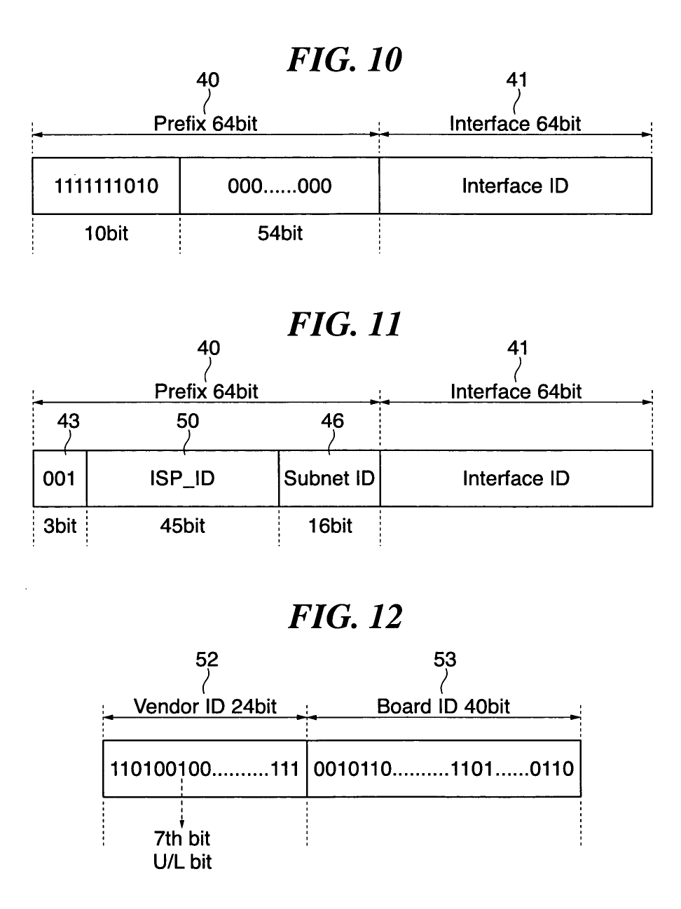

FIG. 10 is a diagram showing the structure of an IPv6 link local address.

In the link local address, the first 10 bits in the 64-bit network address section (prefix) 40 are set at “1111111010”, and the remaining 54 bits at “0”. That is, the network address is set at “fe80::” (in hexadecimal). An ID that specifies an IPv6 compliant terminal apparatus is set in the host address section (interface ID) 41. In the present embodiment, the IPv6 compliant terminal apparatus itself sets the ID thereof based on the MAC address of the network interface processing device in the IPv6 compliant terminal apparatus.

On the Internet where a plurality of links (networks) that can communicate using IPv6 protocol are interconnected, an IP address that enables one-to-one packet communication between terminals is called a “unicast address”. On an IPv6 Internet, a unicast address is a globally uniquely IP address.

FIG. 11 is a diagram showing the structure of an IPv6 unicast address.

The unicast address is composed of the network address section (prefix) 40, and the host address section (interface ID) 41. As described above with reference to FIG. 9, the network address section 40 has an address architecture that provides hierarchical network addresses, and starting with the “001” of the address-type identifier FP 43, is made up of an ISP_ID 50 (corresponding to TLA 44, RE 47, and NLA 45 appearing in FIG. 9) that identifies an ISP, and a SLA 46 showing the subnet address. An ID that is unique to the IPv6 compliant terminal apparatus is set in the host address section 41.

Next, the method of generating an IPv6 host address from a MAC address assigned to a network interface processing device of an IPv6 compliant terminal apparatus will be described. Before doing so, the MAC address will be described. The MAC address has two address formats: IEEE/EUI-64 format and IEEE 802 format.

FIG. 12 is a diagram showing the structure of an IEEE/EUI-64 format MAC address assigned to an IPv6 compliant terminal apparatus.

The IEEE/EUI-64 format MAC address is composed of a 64-bit ID. The first 24 bits are a vendor ID (enterprise ID) 52 composed of an ID uniquely assigned to an enterprise that has manufactured the network interface processing device. The seventh bit from the start of the vendor ID 52 is called the “U/L” (Universal/Local) bit, and is set at “1” when used in local administration (a LAN environment or the like) and at “0” when used in global administration (an Internet environment or the like). The latter 40 bits is a board ID 53. The network interface processing device is shipped after being uniquely assigned an ID under the administration of the enterprise that has manufactured the network interface processing device.

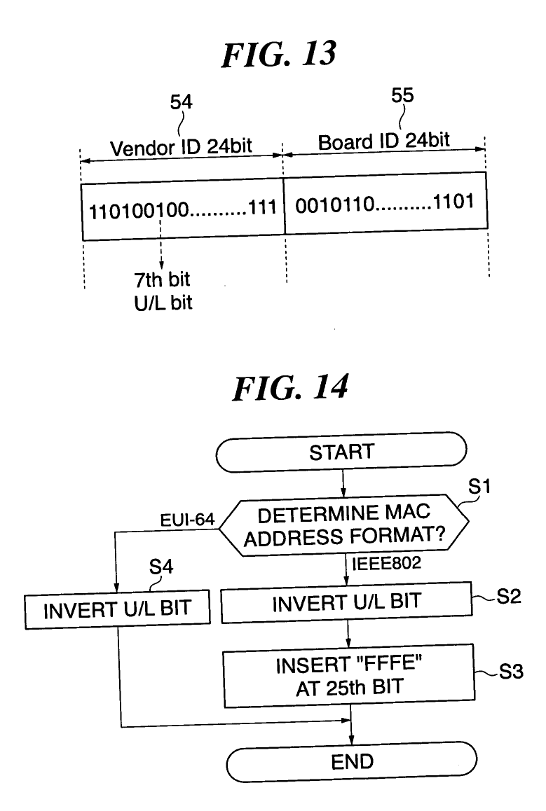

FIG. 13 is a diagram showing the structure of an IEEE 802-format MAC address.

The IEEE 802-format MAC address is composed of a 48-bit ID. The former 24 bits are a vendor ID 54, and has the same structure as the vendor ID 52 in the IEEE/EUI-64 format MAC address shown in FIG. 12. The latter 24 bits are a board ID 55 in which a unique ID that identifies the network interface processing device of an individual IPv6 compliant terminal apparatus is set.

FIG. 14 is a flowchart showing the procedure of a generation process executed by an IPv6 compliant terminal apparatus to generate an IPv6 host address based on a MAC address.

When the IPv6 compliant terminal apparatus 1 is connected to the network, a program stored in the IPv6 compliant terminal apparatus 1 is executed to start the generation process.

In a step S1, the format of the MAC address of the IPv6 compliant terminal apparatus 1 is determined. If the MAC address is EUI-64 format, the process proceeds to a step S4, while if the MAC address is IEEE 802 format, the process proceeds to a step S2.

In the step S4, the seventh bit (U/L bit) of the vendor ID 52 is inverted to generate the IPv6 host address and the present process is terminated.

In the step S2, the seventh bit (U/L bit) of the vendor ID 54 is inverted, and in a step S3, the 16 bit-identifier “fffe” is inserted at the 25th bit that is the boundary between the vendor ID 54 and the board ID 55 to generate an IPv6 host address that is a total of 64 (=24+16+24) bits long, and the present process is terminated.

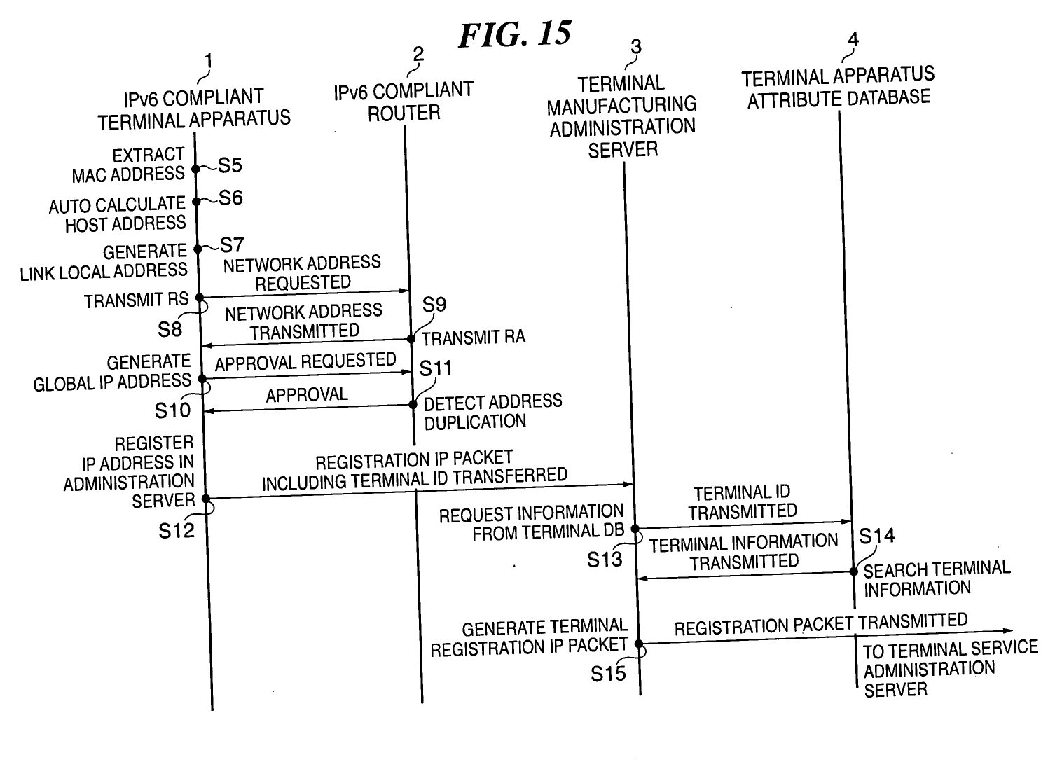

FIG. 15 is a sequence diagram showing procedures for registering the host address section 41 from the terminal manufacturing factory site 5 in the terminal service provider site 6.

When the IPv6 compliant terminal apparatus 1 is connected to the IPv6 compliant router 2 set up in an inspection process administered by the terminal manufacturing factory site 5 inside a terminal manufacturing factory, in a step S5, the IPv6 compliant terminal apparatus 1 extracts the MAC address assigned to the network interface processing device of the IPv6 compliant terminal apparatus 1. In a step S6, in the generation process described above with reference to FIG. 14, the IPv6 compliant terminal apparatus 1 generates the IPv6 host address, which identifies the IPv6 compliant terminal apparatus 1, from the extracted MAC address. Next, in a step S7, the IPv6 compliant terminal apparatus 1 sets “fe80::”, which is the network ID indicating a link local address, in the host address section 41 of the IPv6 host address, thereby generating the link local address.

In a step S8, the IPv6 compliant terminal apparatus 1 transmits a RS (Router Solicitation) to enquire about the network address to the IPv6 compliant router 2 present inside the same link. In a step S9, the IPv6 compliant router 2 that has received the RS transmits a RA (Router Advertisement) to notify the IPv6 compliant terminal apparatus 1 of the network address that is the identifier of the network.

In a step S10, the IPv6 compliant terminal apparatus 1 determines the global IP address (unicast address) of the IPv6 compliant terminal apparatus 1 based on the notified network address and the host address generated in the step S6, and notifies the IPv6 compliant router 2 of an approval request. The IPv6 compliant router 2 that has received the approval request detects address duplication to confirm that there is no other IPv6 compliant terminal apparatus with the same IPv6 global IP address in the same link and, if there is no such apparatus, sends an approval notification showing that use of that global IP address is permitted to the IPv6 compliant terminal apparatus 1.

In a step S12, the IPv6 compliant terminal apparatus 1 that has received the use permitted notification transmits a registration IP packet with the terminal apparatus ID stored in a payload section thereof, to the terminal manufacturing administration server 3 to notify the terminal apparatus ID and the global IP address.

In a step S13, the terminal manufacturing administration server 3 that has received the registration IP packet transmits the terminal apparatus ID to the terminal apparatus attribute database 4 and requests transmission of manufacturing stage attribute information of the IPv6 compliant terminal apparatus 1 that transmitted the registration IP packet. In a step S14, the terminal apparatus attribute database 4 that has received the request extracts the attribute information of the IPv6 compliant terminal apparatus 1 based on the received terminal apparatus ID and sends the information in reply to the terminal manufacturing administration server 3.

In a step S15, the terminal manufacturing administration server 3 that has received the attribute information stores the terminal apparatus ID and the terminal apparatus attribute information in the payload section of a registration IPv6 packet, sets the global IP address of the IPv6 compliant terminal apparatus 1 in the transmitter address of the header section, and transmits the registration IPv6 packet to the terminal service administration server 7.

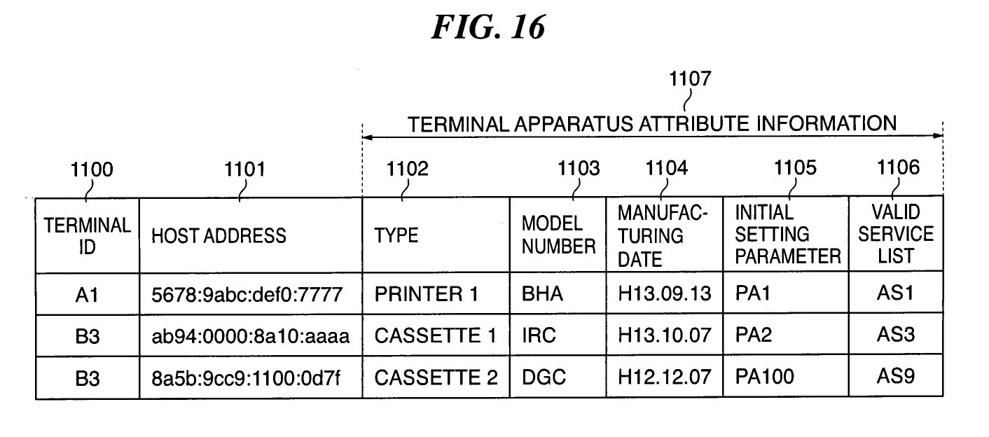

FIG. 16 is a diagram showing one example of the terminal apparatus attribute table stored by the terminal service administration server 7. By transmitting the registration IP packet to the terminal service administration server 7, information is registered in the terminal apparatus attribute table.

In FIG. 16, a terminal ID 1100 is an ID that enables the terminal manufacturer to identify the IPv6 compliant terminal apparatus, and a host address 1101 is an IPv6 host address generated from the MAC address of the IPv6 compliant terminal apparatus. Terminal apparatus attribute information 1107 includes a type 1102, model number 1103, manufacturing date 1104, initial setting parameter 1105, and valid service list 1106 of an IPv6 compliant terminal apparatus. The valid service list 1106 is a list of application services that can be used by the IPv6 compliant terminal apparatus.

The terminal service administration server 7 registers the content of the terminal apparatus attribute table in the terminal-based IPv6 host, address list 8.

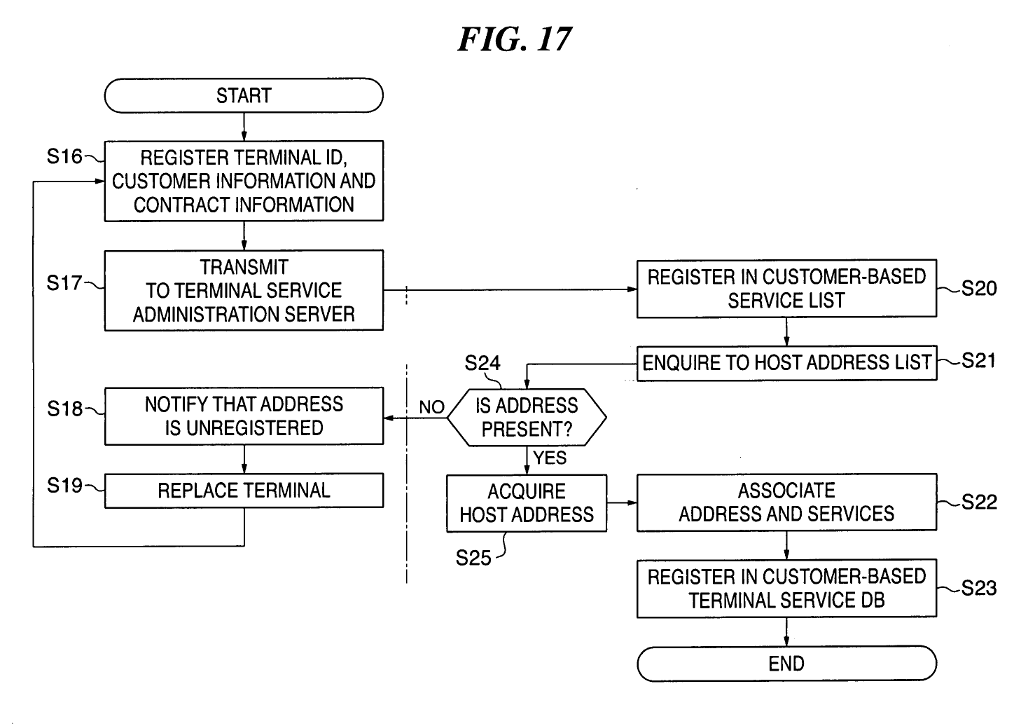

FIG. 17 is a flowchart showing the procedure of a process for generating a customer-based terminal service attribute table and registering the generated table in the customer-based terminal service database 14 by the terminal service administration server 7 of the terminal service provider site 6 to which a customer-based terminal sale record table has been transmitted from the terminal sale administration server 36.

When the IPv6 compliant terminal apparatus 1 is sold to the customer, the retailer uses the client terminal 19 to generate the customer-based terminal sale record table based on sale information, the client terminal 19 transmits the customer-based terminal sale record table to the terminal sale administration server 36, and in a step S16, the terminal sale administration server 36 registers the customer-based terminal sale record table in the customer-based terminal database 17.

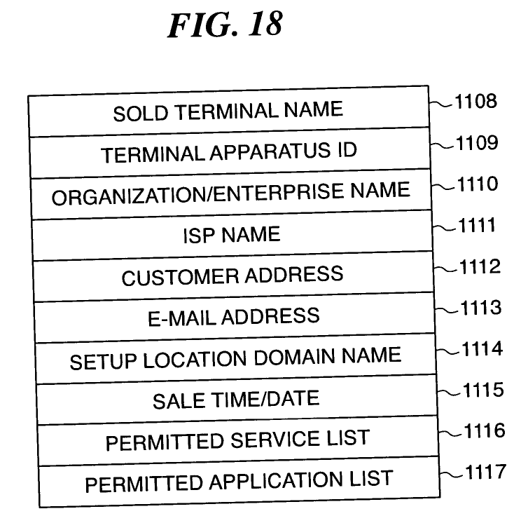

FIG. 18 is a diagram showing the structure of the customer-based terminal sale record table.

In FIG. 18, reference numeral 1108 designates a sold terminal name where a type name of the IPv6 compliant terminal apparatus is written. Reference numeral 1109 designates a terminal apparatus ID where an identifier that enables the terminal manufacturer to identify individual IPv6 compliant terminal apparatuses is written. Reference numeral 1110 designates an organization/enterprise name of the customer who purchased the IPv6 compliant terminal apparatus, 1111 an ISP name of an ISP used by the customer, 1112 a customer address, 1113 an E-mail address of the customer, and 1114 a domain name of the network on which the IPv6 compliant terminal apparatus is set. The organization/enterprise name 1110, the ISP name 1111, and the setup location domain name 1114 are used when searching for the network address, as described later.

Reference numeral 1115 designates a sale time/date showing when the IPv6 compliant terminal apparatus was sold. Reference numeral 1116 designates a permitted service list showing services the customer has signed up for when the IPv6 compliant terminal apparatus was sold, and 1117 a permitted application list showing applications the customer has signed up for when the IPv6 compliant terminal apparatus was sold.

Referring again to FIG. 17, in a step S17, the terminal sale administration server 36 transmits the customer-based terminal sale record table registered in the customer-based terminal database 17 via the Internet 100 to the terminal service administration server 7 of the terminal service provider site 6.

In a step S20, the terminal service administration server 7 that has received the customer-based terminal sale record table records the customer-based terminal sale record table in the customer-based service list 9.

Next, in a step S21, the terminal service administration server 7 enquires whether the IPv6 host address of the corresponding IPv6 compliant terminal apparatus is present among the IPv6 host addresses stored in the terminal-based IPv6 host address list 8, based on the terminal registration IPv6 packet transmitted earlier from the terminal manufacturing administration server 3. If the address is present, the process proceeds to a step S25, while if the address is not present, the process proceeds to a step S18.

In the step S25, the IPv6 host address of the corresponding IPv6 compliant terminal apparatus is obtained from the terminal-based IPv6 host address list 8. In a step S22, the terminal service administration server 7 generates a customer-based terminal service attribute table in which the IPv6 host address and services permitted when the IPv6 compliant terminal apparatus that has the terminal apparatus ID was sold are associated with the terminal apparatus ID as a keyword. In a step S23, the generated customer-based terminal service attribute table is registered in the customer-based terminal service database 14.

In a step S24, the case where the IPv6 host address of the corresponding IPv6 compliant terminal apparatus is not present among the IPv6 host addresses stored in the terminal-based IPv6 host address list 8 is believed to correspond to an irregular case such as where the IPv6 host address was not registered at the terminal manufacturing factory site 5 or where for some reason the address has changed from the registered address after the terminal apparatus was sold. In this case, since the identity of the terminal apparatus is unclear, that is, the terminal apparatus cannot be specified by a global address, the terminal sale administration server 36 notifies that the address is not registered in the step S18 and in a step S19 the terminal is replaced. That is, the IPv6 compliant terminal apparatus 1 being sold to the customer is replaced with another terminal apparatus. After the terminal has been replaced, the process returns to the step S16, and a customer-based terminal sale record table is recorded in the customer-based terminal database 17.

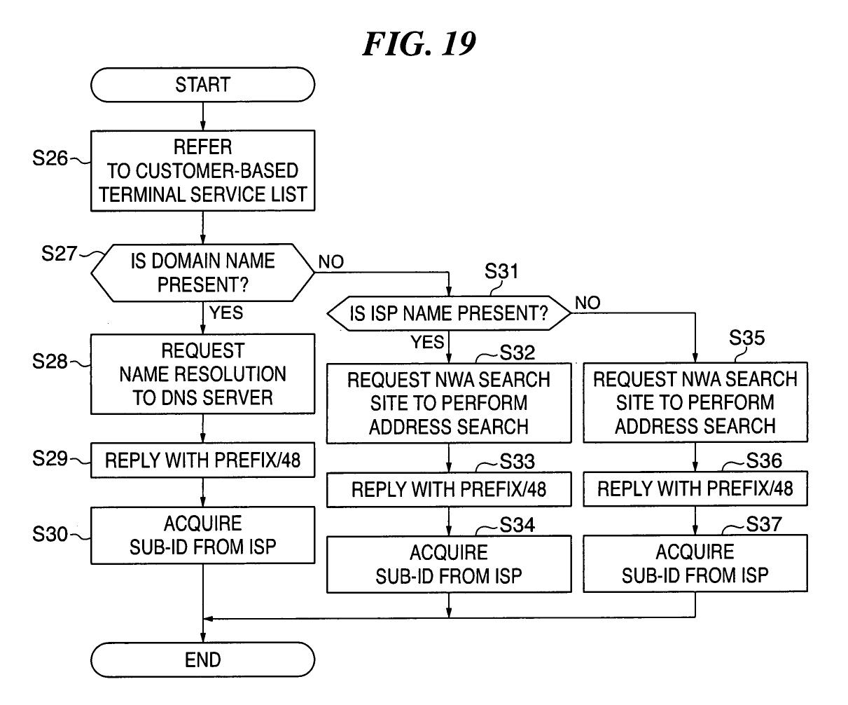

FIG. 19 is a flowchart showing the procedure of a network address search process executed by the terminal service administration server 7.

The terminal service administration server 7 specifies the network address from any of the domain name, ISP name, and an attribute name such as an organization/enterprise name registered in the customer-based service list 9.

That is, first in a step S26, the terminal service management server 7 refers to the customer-based service list 9, and in a step S27, it is determined whether the domain name is registered in the customer-based service list 9. If the domain name is registered, the process proceeds to a step S28, while if the domain name is not registered, the process proceeds to a step S31.

In the step S28, execution of a name resolution process that specifies an IP address based on the domain name is requested to a DNS server on the Internet 100, and in a step S29, data that is upper 48 bits of the network address is acquired from the DNS server. An ISP is specified by this 48-bit network section. Next, in a step S30, an enquiry is made to the specified ISP for the address of a subnet to which the IPv6 compliant terminal apparatus is connected, to acquire a SUB-ID. By executing this process, all 64 bits of the network address are specified.

In the step S31, it is determined whether the ISP name is registered in the customer-based service list 9. If the ISP name is registered, the process proceeds to a step S32, while if the ISP name is not registered, the process proceeds to a step S35.

In the step S32, the NWA search site 20 present on the Internet 100 is requested to search for a network address based on the ISP name. In a step S33, the NWA search site 20 acquires the upper 48 bits of the network address from the provided ISP name and sends the 48 bits to the terminal service administration server 7 in reply. Next, in a step S34, the terminal service administration server 7 specifies the ISP using the received 48-bit data, enquires to the specified ISP for the address of the subnet to which the IPv6 compliant terminal apparatus is connected, to thereby acquire the SUB-ID. By executing the above process, all 64-bits of the network address are specified.

In the step S35, the NWA search site 20 on the Internet 100 is requested to search for a network address based on an attribute name, for example an organization/enterprise name. In a step S36, the NWA search site 20 acquires the upper 48 bits of the network address from the provided attribute name and sends the 48 bits to the terminal service administration server 7 in reply. Next, in a step S37, the terminal service administration server 7 specifies the network address corresponding to the attribute name using the received 48-bit data, enquires to the site having the specified network address for the address of the subnet to which the IPv6 compliant terminal apparatus is connected, to thereby acquire the SUB-ID. By executing the above process, all 64-bits of the network address are specified.

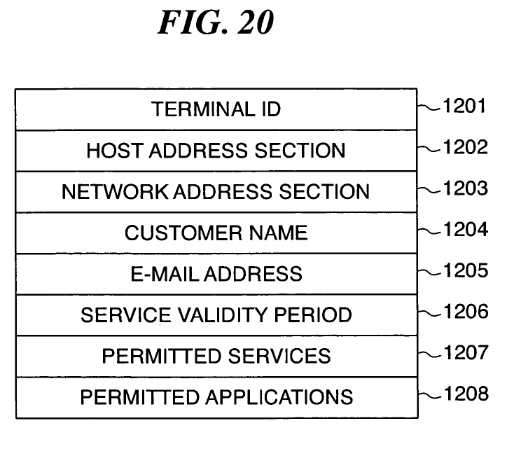

FIG. 20 shows the structure of the customer-based terminal service attribute table generated based on the terminal-based IPv6 host address list 8, the customer-based service list 9, and the customer network address list 10 by the generating section 11 at the terminal service provider site 6, and registered in the customer-based terminal service database 14.

In the customer-based terminal service attribute table, reference numeral 1201 designates a terminal apparatus ID for identifying an IPv6 compliant terminal apparatus manufactured by the terminal manufacturer, and is expressed by a manufacturer's serial number, for example. The terminal apparatus ID is notified to the terminal service provider site 6 from the terminal manufacturing administration server 3 when the IPv6 compliant terminal apparatus is manufactured (i.e., before shipping), and the terminal service provider site 6 is notified of the terminal apparatus ID from the terminal sale administration server 36 when the IPv6 compliant terminal apparatus 1 is sold (i.e., after shipping). The terminal apparatus ID notified in both cases is identical.

Reference numeral 1202 designates an IPv6 host address section of the IPv6 compliant terminal apparatus and is extracted from the terminal-based IPv6 host address list 8. Reference numeral 1203 designates an IPv6 network address section that is extracted from the customer network address list 10. Reference numeral 1204 designates a customer name, 1205 an E-mail address of the customer, 1206 a service validity period, 1207 permitted services (a content of services that can be used due to the customer signing up when the IPv6 compliant terminal apparatus is purchased), and 1208 permitted applications (a content of application software that can be used due to the customer signing up when the IPv6 compliant terminal apparatus is purchased).

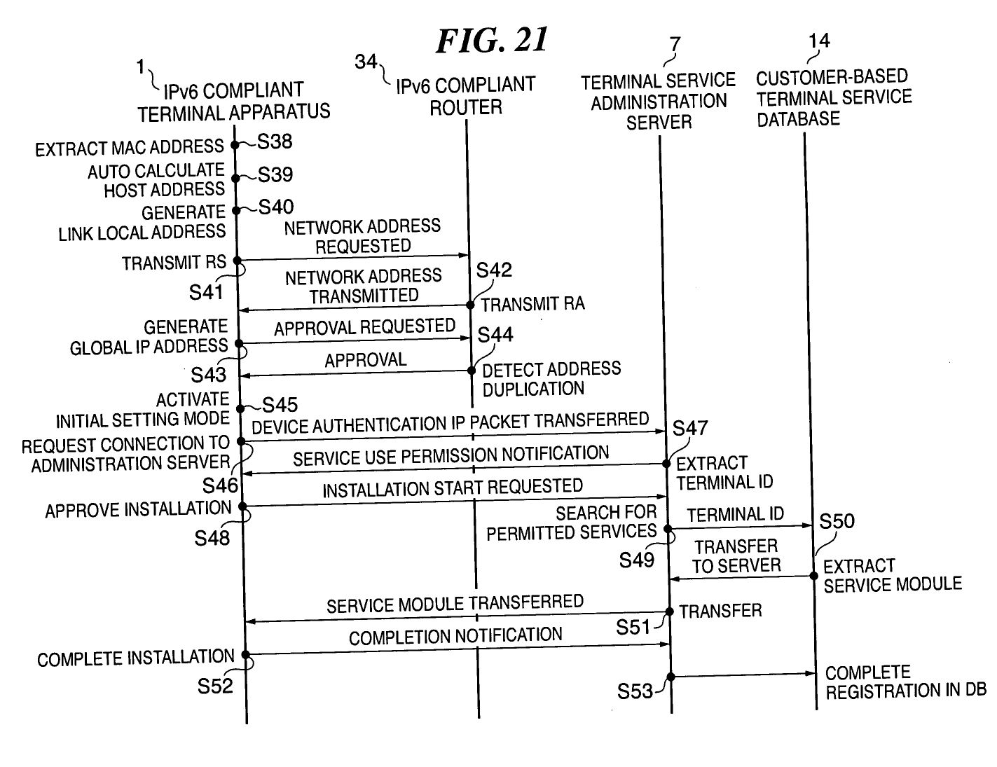

FIG. 21 is a sequence diagram showing the procedures of terminal use registration and service provision carried out by the customer site (LAN 29) and the terminal service provider site 6.

When the IPv6 compliant terminal apparatus 1 is connected to the IPv6 compliant router 34 set up on the LAN 29, in a step S38; the IPv6 compliant terminal apparatus 1 extracts a MAC address assigned to the network interface processing device of the IPv6 compliant terminal apparatus 1. In a step S39, the IPv6 host address for identifying the IPv6 compliant terminal apparatus 1 is generated based on the MAC address in accordance with the generation process of the IPv6 host address shown in FIG. 14. In a step S40, the IPv6 compliant terminal apparatus 1 that has generated the host address generates a link local address by setting “fe80::”, which is the network ID indicating a link local address, in the network section.

In a step S41, the IPv6 compliant terminal apparatus 1 transmits a RS (Router Solicitation) to enquire to an IPv6 compliant router 34 present in the same link about the network address. In a step S42, the IPv6 compliant router 34 that has received the RS transmits a RA (Router Advertisement) to notify the IPv6 compliant terminal apparatus 1 of the network address that is an identifier of the network.

In a step S43, the IPv6 compliant terminal apparatus 1 determines the global IP address (unicast address) of the IPv6 compliant terminal apparatus 1 based on the notified network address and the host address generated in the step S39 and notifies the IPv6 compliant router 34 of the global IP address. In a step S44, the IPv6 compliant router 34 detects address duplication to confirm that there is no other IPv6 compliant terminal apparatus with an identical IPv6 global IP address in the same link, and sends an approval notification showing that use is permitted to the IPv6 compliant terminal apparatus 1.

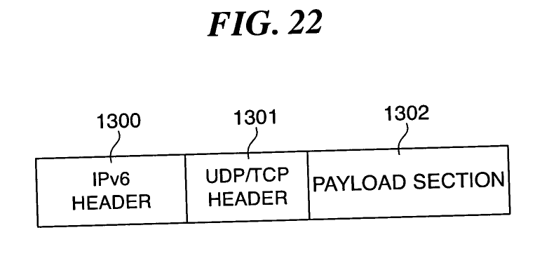

In a step S45, the IPv6 compliant terminal apparatus 1 that has received the use permitted notification sets an initial setting mode to place the IPv6 compliant terminal apparatus 1 in a state where applications can be installed. Next, in a step S46, the IPv6 compliant terminal apparatus 1 transmits a device authentication IP packet, for requesting connection to a terminal service administration server 7, to the terminal service administration server 7 to thereby notify the global IP address of the IPv6 compliant terminal apparatus 1. The device authentication IP packet will now be described with reference to FIG. 22.

FIG. 22 is a diagram showing the structure of an IP packet transmitted from the customer site to the terminal service providing site.

Reference numeral 1300 designates an IPv6 header, and based on IPv6 protocol, the information required to carry out packet communication on the IP layer is stored in the IPv6 header 1300. A router that transfers an IP packet routes the IP packet using the information in the IPv6 header 1300 to transfer the IP packet to a destination host terminal. The global IP address of the IPv6 compliant terminal apparatus 1 is set in the IPv6 header 1300 as the source IP address of the IPv6 header 1300.

Reference numeral 1301 designates a UDP/TCP header in which control information on a transport layer, which is a higher layer than the IP layer, is stored. Packet information is handed over to a higher-layer application using the UDP/TCP header 1301.

Reference numeral 1302 designates a payload section in which data to be delivered to the destination host is stored. In a step S46 in FIG. 21, a flag requesting the terminal service administration server 7 to carry out device authentication for the IPv6 compliant terminal apparatus 1 is set in the IP packet.

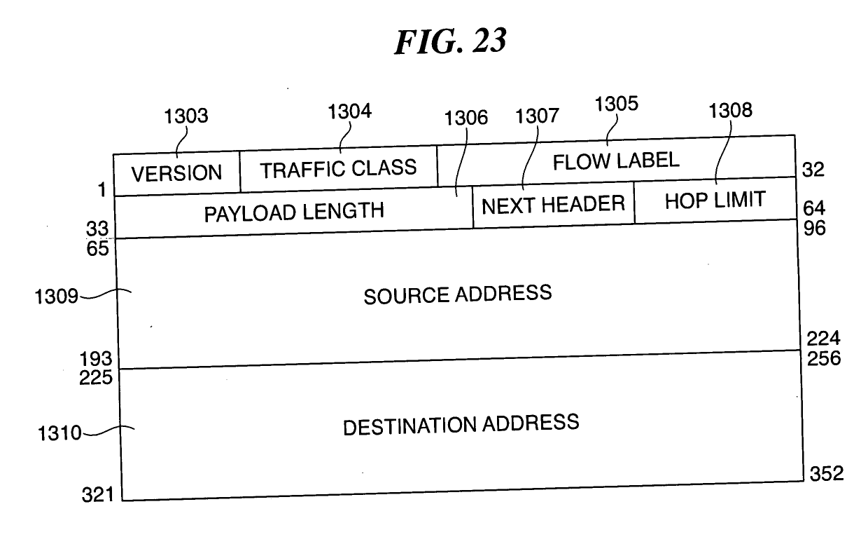

FIG. 23 is a diagram showing the detailed structure of the IPv6 header 1300 of the IP packet.

Reference numeral 1303 designates a version in which a version number of the IP protocol used by the IP packet is set. The field length is 4 bits. Since IPv6 protocol is used in the present embodiment, “6” is set in the version 1303.

Reference numeral 1304 designates a traffic class in which a priority of the packet communication is set. The field length is 8 bits.

Reference numeral 1305 designates a flow label. Information for reserving bandwidth on a predetermined communication network when carrying out communication (for example, real-time communication) that requires a different service quality to a normal service quality is stored in the flow label 1305. The field length is 20 bits.

Reference numeral 1306 designates a payload length in which the length of the payload section 1302 is stored.

Reference numeral 1307 designates a next header in which a type of a header that follows immediately after the IPv6 header 1300 is written. The field length is 8 bits. In the present embodiment, a TCP header is indicated in the next header 1307.

Reference numeral 1308 designates a hop limit in which a hop limit indicative of the maximum number of permitted transfers between nodes (routers) for the IP packet is set. The field length is 8 bits.

Reference numeral 1309 designates a source address field in which an IPv6 address of the transmitter of the IP packet is set. In the present embodiment, the IPv6 global IP address of the IPv6 compliant terminal apparatus 1 is set.

Reference numeral 1310 designates a destination address field in which an IPv6 address of the receiver of the IP packet is set. In the present embodiment, the IPv6 global IP address of the terminal service administration server 7 is set.

Referring again to FIG. 21, in a step S47 the terminal service administration server 7 that has received the device authentication IP packet transmitted from the IPv6 compliant terminal apparatus 1 uses the IPv6 address detecting section 15 (see FIG. 6A) to acquire the global IP address of the IPv6 compliant terminal apparatus 1 from the source address field 1309 of the IPv6 header 1300 of the received IP packet, and refers to the customer-based terminal service database 14 (see FIG. 6A) to specify the terminal apparatus ID. Next, from the specified terminal apparatus ID, the terminal service administration server 7 authenticates the IPv6 compliant terminal apparatus 1 as a device that can use the services of the terminal service administration server 7 and transmits a service use permission notification to the IPv6 compliant terminal apparatus 1.

In a step S48, the IPv6 compliant terminal apparatus 1 that has received the notification carries out a preparation process for installing applications and an installation approval process. That is, an approval screen for requesting a setting of permitted services and permitted applications is displayed on a user interface of the IPv6 compliant terminal apparatus 1, the customer is urged to approve the execution of initial settings in a state where the IPv6 compliant terminal apparatus 1 is connected to the terminal service administration server 7, and the customer is urged to download and set up various permitted services and permitted applications. In accordance with the approval operation performed by the customer, the IPv6 compliant terminal apparatus 1 notifies the terminal service administration server 7 of an installation start request. Note that when the customer has not approved, the setup process is cancelled and the IPv6 compliant terminal apparatus 1 is not able to receive services provided by the terminal service administration server 7.

In a step S49, the terminal service administration server 7 notifies the customer-based terminal service database 14 of the terminal apparatus ID of the IPv6 compliant terminal apparatus 1, and in a step S50, the customer-based terminal service database 14 extracts a service module that can be used by the IPv6 compliant terminal apparatus 1 and transfers the service module to the terminal service administration server 7. In a step S51, the terminal service administration server 7 transmits the service module to the IPv6 compliant terminal apparatus 1.

When the installation is completed, in a step S52 the IPv6 compliant terminal apparatus 1 notifies the terminal service administration server 7 that the installation is complete. In a step S53, the terminal service administration server 7 registers that provision of the service module to the IPv6 compliant terminal apparatus 1 has been completed in the customer-based terminal service database 14.

Next, the registration of sheet types in the customer-based terminal service attribute table stored in the customer-based terminal service database 14 will be described.

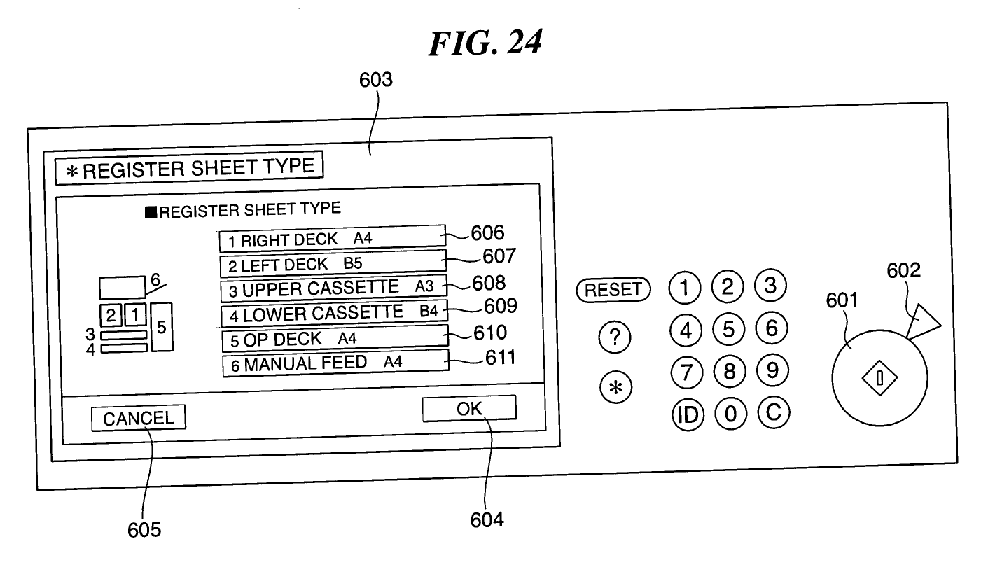

FIG. 24 is a view showing a screen for having the user select a sheet feeding section whose sheet type is to be registered, out of the sheet feeding sections of the IPv6 compliant terminal apparatus.

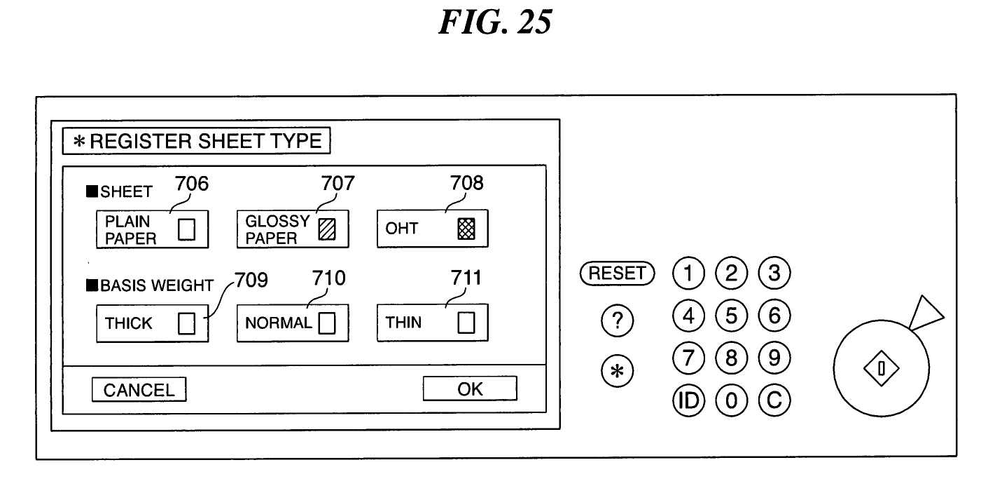

In this screen, sheet types are registered on a sheet feeding section (sheet feeding cassette or sheet feeding deck) basis. In FIG. 24, reference numeral 601 designates a copy start key, 602 a stop key, 603 a liquid crystal touch panel display section, 604 an OK key, and 605 a cancel key. In the example screen shown on the liquid crystal touch panel display section 603, six sheet feeding sections 606 to 611 are displayed, and when one of such sheet feeding sections 606 to 611 is selected by the user, the screen displayed on the liquid crystal touch panel display section 603 changes to a registration screen shown in FIG. 25.

FIG. 25 is a view showing a screen for registering a sheet type for the sheet feeding section selected by the user.

This screen is used to register in advance a type of sheet loaded onto a sheet feeding cassette or deck. The type of sheet is selected by touching one of a plain paper touch key 706, a glossy paper touch key 707, and an OHT touch key 708. The thickness (basis weight) of the sheet is selected by touching one of touch keys 709, 710, and 711.

Although the thickness of sheets is displayed using three levels “thick”, “normal”, and “thin” in the present embodiment, product names of transfer sheets that are recommended for use may be displayed or the basis weight may be displayed in grams.

If the number of transfer sheets inside a sheet feeding section falls during a copy job, it can be detected that the sheets are being used by the job. The remaining amount of transfer sheets is constantly monitored, and if the number of transfer sheets suddenly rises, it can be assumed that a number of transfer sheets corresponding to the increase have been added. Also, the sheet transfer section counts the time period that has passed since the most recent feeding of a sheet and sets the count value as a standing time period. From this standing time period and an output value from the temperature/humidity sensor 180, it is possible to detect how long a transfer sheet has been left in what kind of environment and to change image formation parameters to results of the detection.

Next, changes to the image formation parameters will be described.

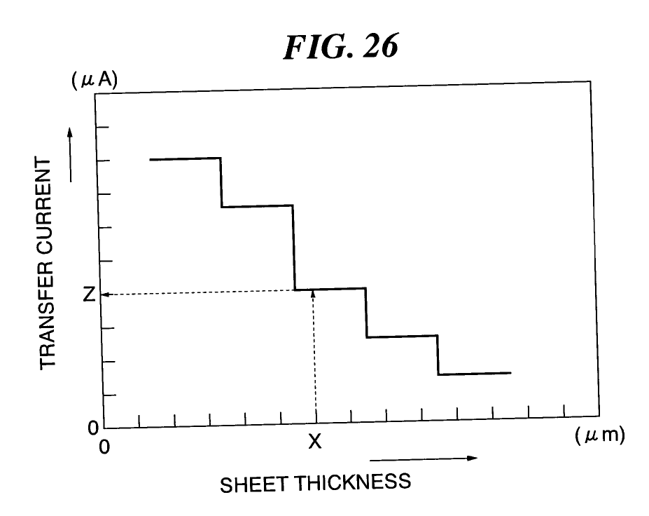

FIG. 26 is a graph showing the relationship between a paper thickness X of standard transfer sheets and an optimal transfer current value Z.

That is, the paper thickness X of standard transfer sheets is divided into a plurality of thickness ranges and one transfer current value Z is set for each thickness range. The sheet thickness X (μm) of a transfer sheet is detected based on a detection output (mW) from a photodiode, not shown, provided in each sheet feeding section, a suitable transfer current value Z (μA) for the sheet thickness X is determined from the relationship shown in FIG. 26, and the high voltage unit 213 (see FIG. 2A) for the transfer device is controlled so as to produce the determined transfer current value Z.

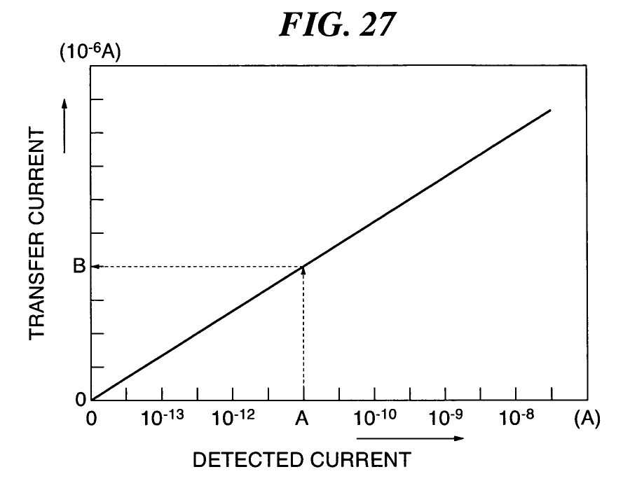

FIG. 27 is a graph showing the relationship between the electrical resistance of a transfer sheet, and moreover a detected current indicative of the sheet thickness of the transfer sheet, and the optimal transfer current value.

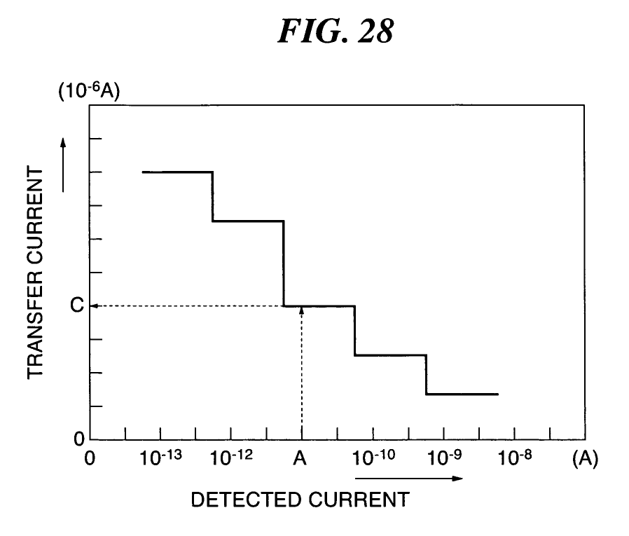

In FIG. 27, when the detected current value indicative of the electrical resistance of the transfer sheet is “A”, the optimal transfer value is set to “B”. This detected current flows in a transfer sheet due to charge accumulated on the transfer sheet, for example, and can be detected by a current detecting means, not shown, provided in each sheet feeding section. However, the transfer current value does not always need to be controlled with respect to the electrical resistance value of the transfer sheet as precisely as the linear relationship shown in FIG. 27. In the same way as the setting of the optimal transfer current value in accordance with the sheet thickness in FIG. 26, the entire range of detected current may be divided into a plurality of ranges and one transfer current may be set for each current range. More specifically, as shown in FIG. 28, the optical transfer current value is set for each detected current range and the transfer device high voltage unit 213 is controlled so as to produce the transfer current value “C” when the detected current is “A”, for example.

The image formation parameters may also change according to the basis weight and an image quality mode.

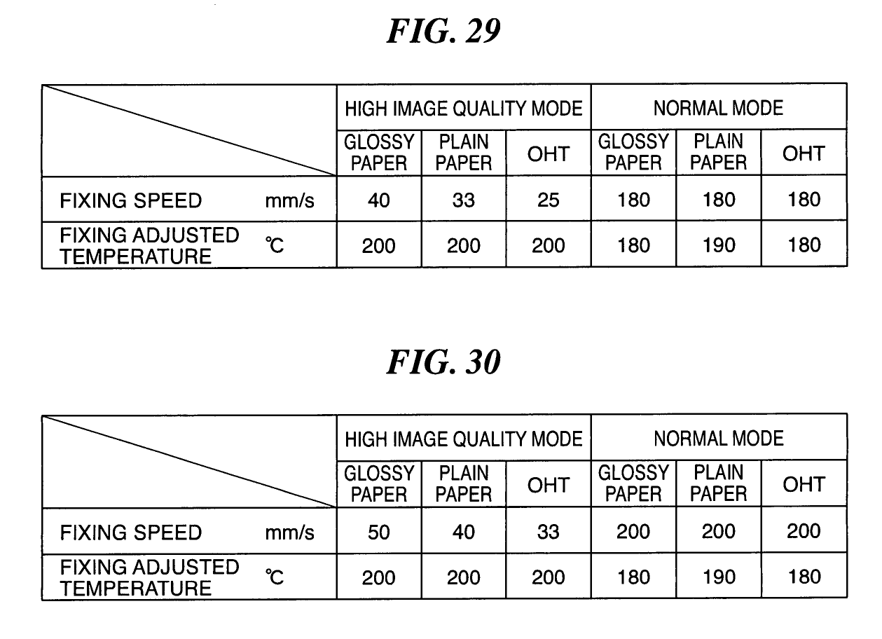

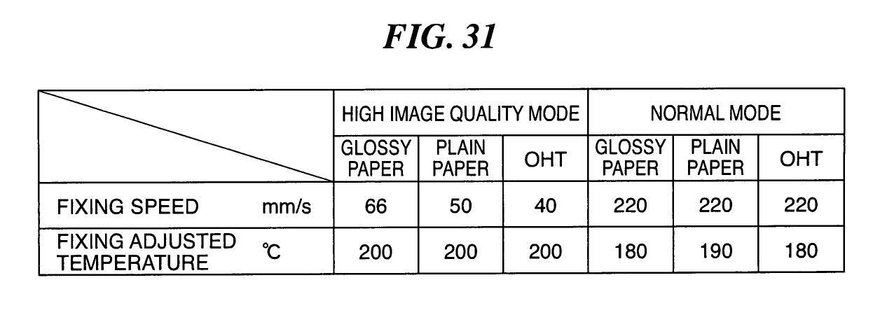

FIGS. 29 to 31 are diagrams showing examples of settings of the image formation parameters (fixing speed and fixing adjusted temperature) in accordance with the basis weight of the transfer sheet, the image quality mode, and the sheet type. FIG. 29 shows an example of settings for the case where the basis weight of the transfer sheet is high, FIG. 30 an example of settings for the case where the basis weight is a medium weight, and FIG. 31 an example of settings for the case where the basis weight is low.

In high-quality mode, the fixing speed (process speed) is set slower than in normal mode. When the fixing speed is set in this way, the current value of a high charging voltage and a high charging voltage AC frequency are also changed in accordance with the rate of change in the fixing speed. At this time, the quantity of light of the laser used for laser exposure is also at a rate in accordance with the rate of change of the fixing speed.

In addition, when a test print operation is carried out by the image forming apparatus at the factory, the positions on sheets fed from the respective sheet feeding cassettes at which images are formed are measured so that a precise positional relationship between the sheet feeding cassettes and the image forming apparatus, sheet feeding peculiarities, and the like can be known. By inputting such measurement values into the operating section, the precise positional relationship and peculiarities of the individual sheet feeding cassettes are registered. By registering such information in association with addresses assigned to the individual sheet feeding cassettes and sheet feeding decks before shipping from the factory, even when the sheet feeding cassettes and sheet feeding decks are replaced, the optimal image position can be obtained without reinputting adjustment values. Adjustment of the image position is carried out in timing of the writing of an image on the photosensitive drum 110 by laser light.

As described above, according to the present embodiment, in particular when a sheet feeding cassette or sheet feeding deck has been replaced with another, various information related to the other sheet feeding cassette or sheet feeding deck and the transfer sheets inside the sheet feeding cassette or sheet feeding deck is read from the terminal service administration server 7 and the image formation parameters are set based on such various information. As a result, image formation in accordance with the other sheet feeding cassette or sheet feeding deck and the transfer sheets inside the sheet feeding cassette or sheet feeding deck can be carried out easily.

It is to be understood that the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read out from the storage medium realizes the new functions of the present invention, and hence the program code and the storage medium in which the program code is stored constitute the present invention.

Examples of the storage medium for supplying the program code include a flexible disk, a hard disk, a magneto-optical disk, an optical disk, such as a CD-ROM, a CD-R, a CD-RW, a DVD-ROM, a DVD-RAM, a DVD-RW, and a DVD+RW, a magnetic tape, a nonvolatile memory card, and a ROM. Alternatively, the program may be supplied by downloading from another computer, a database, or the like, not shown, connected to the Internet, a commercial network, a local area network, or the like.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Applications Nos. 2004-223359 filed Jul. 30, 2004, and 2005-216061 filed Jul. 26, 2005, which is hereby incorporated by reference herein.

What is claimed is:

1. An image forming system comprising:
an image forming apparatus;
an information storage apparatus connected to said image forming apparatus via a network;
a plurality of transfer sheet storage units that are detachably attached to said image forming apparatus, and feed transfer sheets to said image forming apparatus, said transfer sheet storage units being assigned respective identification codes;
a predetermined information storage device that is provided in said information storage apparatus and stores predetermined information related to respective ones of said transfer sheet storage units, in association with the respective identification codes assigned to said plurality of transfer sheet storage units;
a predetermined information obtaining device that is provided in said image forming apparatus and is operable when image formation is carried out on a transfer sheet, to acquire the identification code of the transfer sheet storage unit that stores the transfer sheet and obtain the predetermined information corresponding to the obtained identification code from said information storage apparatus; and
an image forming device that is provided in said image forming apparatus, determines at least one image formation parameter based on the predetermined information obtained by said predetermined information obtaining device, and carries out image formation on the transfer sheet based on the determined image formation parameter.

2. An image forming system according to claim 1, wherein the predetermined information stored by said predetermined information storage device indicates characteristics of transfer sheets contained in the respective transfer sheet storage units.

3. An image forming system according to claim 1, wherein the predetermined information stored by said predetermined information storage device indicates states of the transfer sheets contained in the respective transfer sheet storage units.

4. An image forming system according to claim 3, wherein the predetermined information indicative of the states of the transfer sheets indicates at least one of a standing time period and a peripheral temperature and humidity of transfer sheets contained in the respective transfer sheet storage units.

5. An image forming system according to claim 1, wherein the predetermined information stored by said predetermined information storage device comprises information related to attachment states of the respective transfer sheet storage units to said image forming apparatus.

6. An image forming system according to claim 1, wherein the respective identification codes assigned to said plurality of transfer sheet storage units comprise addresses on said network.

7. An image forming system according to claim 1, wherein said image forming apparatus is an electrophotographic image forming apparatus including a transfer device, and a photosensitive drum, and
the image formation parameter determined by said image forming device includes at least one parameter selected from the group consisting of a voltage value of a high voltage supplied to the transfer device, a quantity of exposure light, an image formation position on the photosensitive drum, and a process speed of said image forming device.

8. An image forming method applied to an image forming system including an image forming apparatus, a plurality of transfer sheet storage units that are detachably attached to the image forming apparatus, and feed transfer sheets to the image forming apparatus, and an information storage apparatus connected to the image forming apparatus via a network, the image forming method comprising:
a predetermined information storing step of storing predetermined information related to respective ones of the transfer sheet storage units in association with respective identification codes assigned to the plurality of transfer sheet storage units, in the information storage apparatus;
a predetermined information obtaining step of acquiring an identification code of a transfer sheet storage unit that stores a transfer sheet on which image formation is carried out and obtaining the predetermined information corresponding to the obtained identification code from the information storage apparatus, when the image forming apparatus carries out image formation on the transfer sheet; and
an image formation executing step of determining at least one image formation parameter based on the predetermined information obtained in said predetermined information obtaining step, and carrying out image formation on the transfer sheet based on the determined image formation parameter.

9. An image forming method according to claim 8, wherein the predetermined information stored in said predetermined information storage step indicates characteristics of transfer sheets contained in the respective transfer sheet storage units.

10. An image forming method according to claim 8, wherein the predetermined information stored in said predetermined information storage step indicates states of the transfer sheets contained in the respective transfer sheet storage units.

11. An image forming method according to claim 8, wherein the predetermined information stored in said predetermined information storage step comprises information related to attachment states of the respective transfer sheet storage units to the image forming apparatus.

12. An image forming method according to claim 8, wherein the respective identification codes assigned to said plurality of transfer sheet storage units comprise addresses on the network.

13. An image forming method according to claim 8, wherein the image forming apparatus is an electrophotographic image forming apparatus including a transfer device, and a photosensitive drum, and
the image formation parameter determined in said image formation executing step includes at least one parameter selected from the group consisting of a voltage value of a high voltage supplied to the transfer device, a quantity of exposure light, an image formation position on the photosensitive drum, and a process speed of said image formation executing step.

14. A program for causing a computer to execute an image forming method applied to an image forming system including an image forming apparatus, a plurality of transfer sheet storage units that are detachably attached to the image forming apparatus, and feed transfer sheets to the image forming apparatus, and an information storage apparatus connected to the image forming apparatus via a network, the program comprising:
a predetermined information storing module for storing predetermined information related to respective ones of the transfer sheet storage units in association with respective identification codes assigned to the plurality of transfer sheet storage units, in the information storage apparatus;
a predetermined information obtaining module for acquiring an identification code of a transfer sheet storage unit that stores a transfer sheet on which image formation is carried out and obtaining the predetermined information corresponding to the obtained identification code from the information storage apparatus, when the image forming apparatus carries out image formation on the transfer sheet; and
an image formation executing module for determining at least one image formation parameter based on the predetermined information obtained by said predetermined information obtaining module, and carrying out image formation on the transfer sheet based on the determined image formation parameter.
